(19) United States
(12) Patent Application Publication
(10) Pub. No.: US 2015/0264788 A1
(43) Pub. Date: Sep. 17, 2015

(54) Static Eliminator And Static Elimination Head

(71) Applicant: Keyence Corporation, Osaka (JP)

(72) Inventors: Nobuhiro Hayashi, Osaka (JP); Saeyoung Yang, Osaka (JP)

(73) Assignee: KEYENCE CORPORATION, Osaka (JP)

(21) Appl. No.: 14/628,309

(22) Filed: Feb. 23, 2015

(30) Foreign Application Priority Data
Mar. 14, 2014 (JP) 2014-052509

(51) Int. Cl. H05F 3/06; H01T 23/00

(52) U.S. Cl. CPC H05F 3/06; H01T 23/00

(57) ABSTRACT

Provided is a static eliminator and a static elimination head which are capable of sufficiently eliminating static electricity irrespective of a surrounding environment thereof. Humidified air is generated by humidification of air by the humidified air generating part. The humidified air is allowed to flow out of an air flow outlet of a static elimination head. Further, one or a plurality of static elimination needles and a ground electrode are held in the static elimination head. A voltage for generating corona discharge is applied by a power supply device between the one or the plurality of static elimination needles and the ground electrode. The one or plurality of static elimination needles are arranged in the static elimination head such that ions generated by the corona discharge are sent out by the humidified air that is allowed to flow out of the air flow outlet.

### CROSS-REFERENCE TO RELATED APPLICATIONS

The present application claims foreign priority based on Japanese Patent Application No. 2014-052509, filed Mar. 14, 2014, the contents of which is incorporated herein by reference.

### BACKGROUND OF THE INVENTION

1. Field of the Invention

The present invention relates to a static eliminator and a static elimination head which eliminate static electricity on a static elimination object.

2. Description of Related Art

In a clean room where semiconductor devices or the like are manufactured, there is used a static eliminator for eliminating static electricity in air or preventing a workpiece to be manufactured from being charged, for example. A static eliminator described in JP 2007-311229 A is provided with a main unit and a louver. A discharge electrode and a fan are housed in the main unit. Ions generated from the discharge electrode are sent out to the outside through the louver by rotation of the fan.

The louver includes a lattice-shaped fin in a frame. A portion of the fin which is closer to the center side in a radial direction of the fan is formed more thickly in an axial direction of the fan. An ion flow extruded by the fan is controlled by the thickly formed portion of the fin so as to travel in a straight direction. Hence, the straightness of the ion flow is enhanced, to give the static elimination effect in a wider range of area.

The static elimination effect by the static eliminator varies depending on a surrounding environment of the static elimination object. Hence, the static elimination effect of the static eliminator of JP 2007-311229 A may be insufficient depending on the season.

### SUMMARY OF THE INVENTION

An object of the present invention is to provide a static eliminator and a static elimination head which are capable of sufficiently eliminating static electricity irrespective of a surrounding environment.

(1) A static eliminator according to one embodiment of the invention is a static eliminator for eliminating static electricity on an object, the static eliminator including: a humidified air generating part that humidifies air to generate humidified air; a holding body that has a flow outlet for allowing the humidified air, generated by the humidified air generating part, to flow out; one or a plurality of static elimination electrodes held in the holding body; an electrode that is held in the holding body; and a power supply device that applies a voltage between the one or the plurality of static elimination electrodes and the electrode to generate corona discharge. The one or the plurality of static elimination electrodes are arranged in the holding body such that ions generated by the corona discharge are sent out by the humidified air that is allowed to flow out of the flow outlet.

In this static eliminator, humidified air is generated by humidification of air by the humidified air generating part. The humidified air is allowed to flow out of the flow outlet of the holding body. Further, the one or the plurality of static elimination electrodes and an electrode are held in the holding body. A voltage for generating corona discharge is applied by the power supply device between the one or the plurality of static elimination electrodes and the electrode.

Here, the one or the plurality of static elimination electrodes are arranged in the holding body such that ions generated by the corona discharge are sent out by the humidified air. According to this configuration, static electricity on the object is eliminated by supplying the humidified air to the object, and the static electricity on the object is further eliminated by supplying the ions to the object. Moreover, the static elimination effect is improved as compared to the case where the ions are sent out by low-humidity air. Furthermore, even in a low-humidity environment, it is possible to obtain the static elimination effect to a certain extent or more. Consequently, this enables sufficient elimination of static electricity irrespective of a surrounding environment.

(2) The static eliminator may further include a temperature adjusting part that adjusts a temperature of air, and the humidified air generating part may humidify air whose temperature has been adjusted by the temperature adjusting part.

In this case, since the temperature of the air is adjusted, it is possible to increase an amount of moisture that the air can acquire from the humidified air generating part. Hence, it is possible to further improve the static elimination efficiency.

(3) The static eliminator may further include a controller that controls the temperature adjusting part such that an absolute humidity of the humidified air flowing out of the flow outlet is equal to or lower than a saturated steam amount of air around the object.

In this case, the absolute humidity of the humidified air which is supplied to the object is equal to or lower than the saturated steam amount of the air around the object. Hence, it is possible to prevent condensation on the object.

(4) The static eliminator may further include: a temperature measuring part that measures a temperature of the humidified air generated by the humidified air generating part; and an external temperature acquiring part that acquires a temperature of external air, wherein the first controller may control the temperature adjusting part such that the humidified air temperature measured by the temperature measuring part is equal to or lower than the external air temperature acquired by the external temperature acquiring part.

In this case, based on the humidified air temperature measured by the temperature measuring part and the external air temperature acquired by the external temperature acquiring part, it is possible to easily prevent condensation on the object. Further, according to this configuration, there is no need to directly measure relative humidities of the inside and the flow outlet of the static eliminator, and hence it is possible to simplify the configuration of the static eliminator.

(5) The static eliminator may further include: a temperature measuring part that measures a temperature of the humidified air generated by the humidified air generating part; an external temperature acquiring part that acquires a temperature of external air; an input part for inputting a target relative humidity; and a second controller that estimates an absolute humidity of the humidified air based on the humidified air temperature measured by the temperature measuring part, and controls the temperature adjusting part such that a relative humidity at the external air temperature acquired by the external temperature acquiring part becomes the target relative humidity, the relative humidity being calculated based on the absolute humidity.

In this case, based on the humidified air temperature measured by the temperature measuring part and the external air temperature acquired by the external temperature acquiring part, it is possible to facilitate the humidity control. Further, according to this configuration, there is no need to directly measure absolute humidities and relative humidities of the inside and the flow outlet of the static eliminator, and hence it is possible to simplify the configuration of the static eliminator.

(6) The electrode may include first and second counter electrodes that are arranged so as to be opposed to each other, the one or the plurality of static elimination electrodes may be arranged between the first counter electrode and the second counter electrode, and the flow outlet may include a first flow outlet that allows the humidified air to flow out between the first counter electrode and the one or the plurality of static elimination electrodes, and a second flow outlet that allows the humidified air to flow out between the second counter electrode and the one or the plurality of static elimination electrodes.

In this case, ions generated between the first counter electrode and the one or the plurality of static elimination electrodes are sent out by the humidified air that is allowed to flow out of the first flow outlet. Further, ions generated between the second counter electrode and the one or the plurality of static elimination electrodes are sent out by the humidified air that is allowed to flow out of the second flow outlet. According to this configuration, the ions generated on both sides of each static elimination electrode can be efficiently sent out by the humidified air. Hence, it is possible to efficiently eliminate static electricity on the object.

(7) The one or the plurality of static elimination electrodes may be provided so as to be located in the humidified air that is allowed to flow out of the flow outlet.

In this case, the ions generated around each static elimination electrode can be efficiently sent out by the humidified air. This facilitates efficient elimination of static electricity on the object.

(8) The electrode may be formed so as to annularly surround a periphery of each of the static elimination electrodes, and the flow outlet may allow the humidified air to flow to an annular region between each of the static elimination electrodes and the electrode.

In this case, the ions generated around each static elimination electrode can be efficiently sent out by the humidified air. This facilitates efficient elimination of static electricity on the object.

(9) The holding body may include a casing that has an internal space, a flow inlet, and the flow outlet, and houses at least a part of the one or the plurality of static elimination electrodes, and the static eliminator may further include a supply tube that leads the humidified air generated by the humidified air generating part to the flow inlet of the casing.

In this case, the humidified air generated by the humidified air generating part is led to the casing by the supply tube. Hence, it is possible to separate the casing and the humidified air generating part. This facilitates arrangement of the one or the plurality of static elimination electrodes of the casing in the vicinity of the object. As a result, it is possible to improve the static elimination efficiency.

(10) The casing may include first and second casings, the one or the plurality of static elimination electrodes may include a first number of first static elimination electrodes that are held in the first casing, and a second number of second static elimination electrodes that are held in the second casing, the first number may be larger than the second number, the electrode may include a first electrode that is held in the first casing and a second electrode that is held in the second casing, the power supply device may include a first power supply device that applies a voltage between the first static elimination electrode and the first electrode, and a second power supply device that applies a voltage between the second static elimination electrode and the second electrode, the first casing, the first static elimination electrode, the first electrode, and the first power supply device may constitute a first static elimination head, the second casing, the second static elimination electrode, and the second electrode may constitute a second static elimination head, and the first and second static elimination heads may be selectively connectable to and removable from the humidified air, generating part.

In this case, it is possible to select the static elimination head that is connected to the humidified air generating part in accordance with the use and the shape of the object. The number of second static elimination electrodes of the second static elimination head is smaller than the number of first static elimination electrode of the first static elimination head. Further, the second static elimination head may not include the second power supply device, to thereby facilitate reduction of the size of the second static elimination head more than the first static elimination head. Accordingly, the use of the first static elimination head can facilitate elimination of static electricity in a relatively large range or on a relatively large-sized object, and the use of the second static elimination head can facilitate elimination of static electricity in a relatively narrow range or on a relatively small-sized object.

(11) The holding body may include a casing that has the flow outlet and houses at least a part of the one or the plurality of static elimination electrodes and the humidified air generating part.

In this case, the flow outlet, at least a part of the one or the plurality of static elimination electrodes, and the humidified air generating part are integrally provided. Hence, it is possible to simplify the configuration of the static eliminator, and make the static eliminator compact and lightweight.

(12) The electrode may be arranged so as to be vertical to each of the static elimination electrodes and intersect with a plane located at a tip of each of the static elimination electrodes.

In this case, the corona discharge efficiency is improved. Hence, it is possible to further improve the static elimination efficiency.

(13) The static eliminator may further include a rectifying plate that is held in the holding body, and the rectifying plate may be provided so as to rectify the humidified air, which is allowed to flow out of the flow outlet, in a fixed direction.

In this case, the humidified air sent out of the flow outlet is suppressed from being diffused in the air around the flow outlet. Thereby, the humidified air is sent out to a far distance. As a result, it is possible to further improve the static elimination efficiency.

(14) The one or the plurality of static elimination electrodes may be arranged so as to project more than the tip of the rectifying plate in a flow-out direction of the humidified air.

In this case, charging of the rectifying plate with the generated ions is reduced. Hence, it is possible to further improve the static elimination efficiency.

(15) A static elimination head according to another embodiment of the invention is a static elimination head which is connectable to a humidified air generating part for humidifying air to generate humidified air through a supply tube, and eliminates static electricity on an object. The static elimination head includes: a holding body that is connectable to the humidified air generating part through the supply tube, and has a flow outlet for allowing the humidified air generated by the humidified air generating part to flow out; one or a plurality of static elimination electrodes that are capable of applying a voltage for generating corona discharge, and are held in the holding body; and an electrode that is capable of applying a voltage for generating corona discharge, and is held in the holding body. The one or the plurality of static elimination electrodes are arranged in the holding body such that ions generated by the corona discharge are sent out by the humidified air that is allowed to flow out of the flow outlet.

In this static elimination head, the humidified air generated by the humidified air generating part is supplied to the holding body through the supply tube, and allowed to flow out of the flow outlet of the holding body. Further, the one or the plurality of static elimination electrodes and the electrode are held in the holding body. A voltage for generating corona discharge is applied by the power supply device between the one or the plurality of static elimination electrodes and the electrode.

Here, the one or the plurality of static elimination electrodes are arranged in the holding body such that ions generated by the corona discharge are sent out by the humidified air. According to this configuration, static electricity on the object is eliminated by supplying the humidified air to the object, and the static electricity on the object is further eliminated by supplying the ions to the object. Moreover, the static elimination effect is improved as compared to the case where the ions are sent out by low-humidity air. Furthermore, even in a low-humidity environment, it is possible to obtain the static elimination effect to a certain extent or more. This enables sufficient elimination of static electricity irrespective of a surrounding environment.

According to the present invention, it is possible to sufficiently eliminate static electricity irrespective of a surrounding environment.

### BRIEF DESCRIPTION OF THE DRAWINGS

FIG. 1 is an external perspective view of a static eliminator according to a first embodiment of the present invention;

FIG. 2 is a schematic view showing an internal configuration of a humidified air generating part of the static eliminator of FIG. 1;

FIG. 3 is an external perspective view showing a static elimination head in a first example;

FIG. 4 is a vertical sectional view in a width direction of the static elimination head of FIG. 3;

FIG. 5 is an enlarged view of a part A of FIG. 3;

FIG. 6 is a sectional view in a longitudinal direction of the static elimination head of FIG. 3;

FIG. 7 is a sectional perspective view in the width direction of the static elimination head of FIG. 3;

FIG. 8 is an enlarged sectional view of a part B of FIG. 7;

FIG. 9 is an external perspective view showing a static elimination head in a second example;

FIG. 10 is a vertical sectional view of the static elimination head of FIG. 9;

FIG. 11 is a front view of a rectifying plate unit of the static elimination head of FIG. 9;

FIG. 12 is an enlarged view of a part C of FIG. 9;

FIG. 13 is an external perspective view showing a static elimination head in a third example;

FIG. 14 is a vertical sectional view of the static elimination head of FIG. 13;

FIG. 15 is a flowchart showing one example of a temperature control process for humidified air by a controller;

FIG. 16 is a flowchart showing another example of the temperature control process for humidified air by the controller;

FIG. 17 is a schematic external perspective view of a static eliminator according to a second embodiment;

FIG. 18 is an enlarged view of a part D of FIG. 17;

FIG. 19 is a schematic view showing a configuration of a humidifying filter in another system;

FIG. 20 is a plan view showing a first modified example of the rectifying plate unit of the static elimination head;

FIG. 21 is a plan view showing a second modified example of the rectifying plate unit of the static elimination head;

FIGS. 22A and 22B are diagrams showing a static elimination head of Example 1 and static elimination performance of a static eliminator using the static elimination head of Example 1;

FIG. 23 is a diagram showing static elimination performance of static eliminators using static elimination heads of Examples 2 to 4;

FIG. 24 is a diagram showing static elimination performance of static eliminators using static elimination heads of Examples 5 to 7;

FIGS. 25A and 25B are views showing a plurality of barrier ribs of a static elimination head of Example 8;

FIGS. 26A and 26B are views showing a plurality of barrier ribs of a static elimination head of Example 9;

FIGS. 27A and 27B are views showing a plurality of barrier ribs of a static elimination head of Example 10;

FIGS. 28A and 28B are views showing a plurality of barrier ribs of a static elimination head of Example 11;

FIGS. 29A and 29B are diagrams showing static elimination performance of static eliminators using the static elimination heads of Examples 8 to 11;

FIGS. 30A to 30D are views showing static elimination heads of Examples 12 to 15;

FIG. 31 is a diagram showing static elimination performance of static eliminators using the static elimination heads of Examples 12 to 15;

FIGS. 32A to 32D are views showing static elimination heads of Examples 16 to 19;

FIG. 33 is a diagram showing static elimination performance of static eliminators using the static elimination heads of Examples 16 to 19;

FIG. 34 is an external perspective view showing a static elimination head in the case where the rectifying plate is not provided; and

FIG. 35 is a graph showing a relation between a position from the static elimination head and a relative humidity of air.

### DETAILED DESCRIPTION OF PREFERRED EMBODIMENTS

### [1] First Embodiment

Hereinafter, a static eliminator according to a first embodiment of the present invention will be described with reference to the drawings.

### (1) Configuration of Static Eliminator

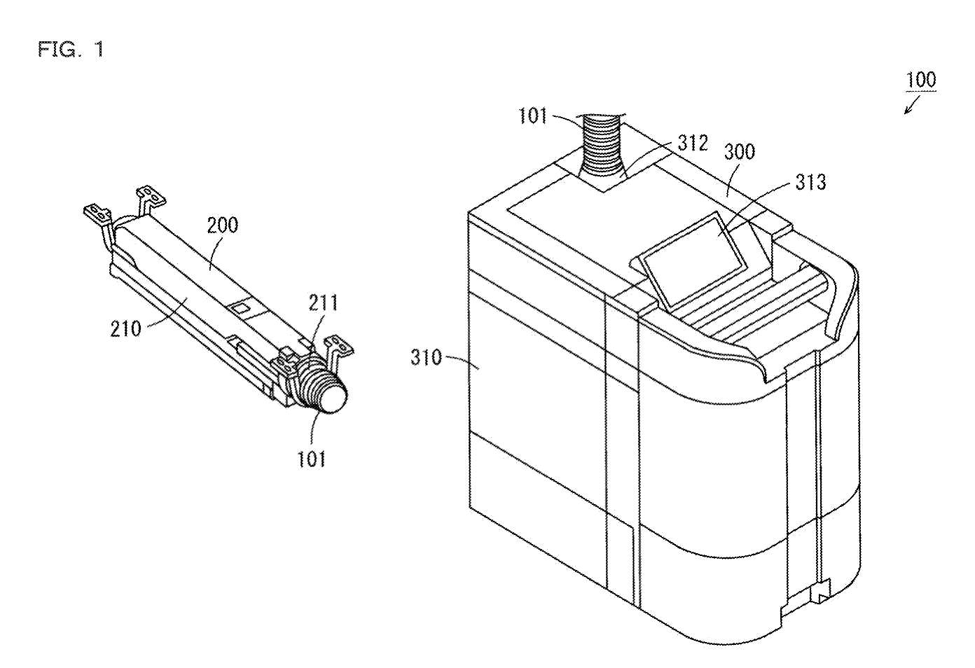

FIG. 1 is an external perspective view of a static eliminator according to the first embodiment of the present invention. As shown in FIG. 1, a static eliminator 100 is configured by a static elimination head 200 and a humidified air generating part 300. The static elimination head 200 and the humidified air generating part 300 are connected through a meander-shaped hose 101. FIG. 1 only shows one end and the other end of the hose 101. A variety of static elimination heads 200 can be connected to the humidified air generating part 300. FIG. 1 shows the static elimination head 200 of a first example, which will be described later.

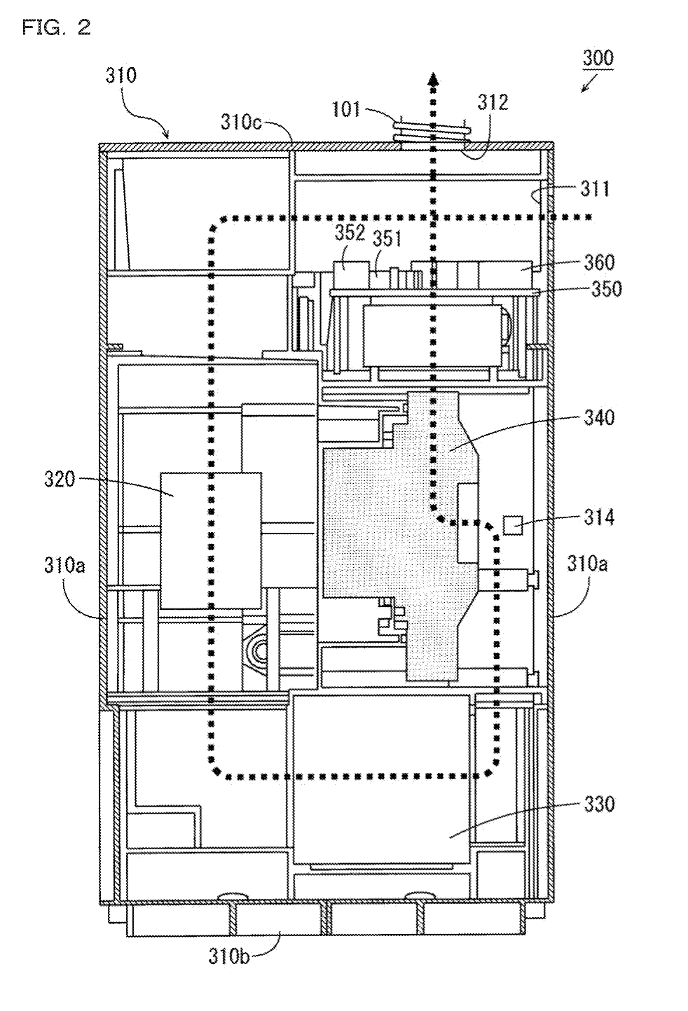

FIG. 2 is a schematic view showing an internal configuration of the humidified air generating part of the static eliminator of FIG. 1. As shown in FIG. 2, the humidified air generating part 300 includes a casing 310, a heater 320, a humidifying filter 330, a turbo fan 340, an electronic substrate 350, and a heat sink 360. In the present example, the humidified air generating part 300 generates humidified air by a hybrid evaporation system. In the hybrid evaporation system, air is heated by the heater 320, to thereby increase an amount of moisture that can be acquired by the air from the evaporation-type humidifying filter 330.

The casing 310 has a substantially rectangular parallelepiped shape formed of four side surfaces 310a, a bottom surface 310b, and a top surface 310c. The heater 320, the humidifying filter 330, the turbo fan 340, the electronic substrate 350, and the heat sink 360 are arranged in the casing 310. An air flow inlet 311 for allowing air to flow into the casing 310 is formed in the upper part of one side surface 310a of the casing 310. An air flow outlet 312 for allowing air inside the casing 310 to flow out is formed on the top surface 310c of the casing 310. One end of the hose 101 of FIG. 1 is connected to the air flow outlet 312.

A display part 313 (cf. FIG. 1) is provided on the top surface 310c of the casing 310. The display part 313 is, for example, configured by an LED (light-emitting diode) panel, and displays an operating state of the static eliminator 100, and the like. Further, by operating the display part 313, a user of the static eliminator 100 can previously input or select a set value of a relative humidity on the surface of the static elimination object. Hence, it is possible to control the relative humidity of the surface of the static elimination object so as to become the set value desired by the user. Consequently, static electricity on the static elimination object can be eliminated without causing condensation on the static elimination object. The details thereof will be described later.

In FIG. 2, a flow channel of air inside the casing 310 is indicated by an arrow with a thick dotted line. Air having flown from the air flow inlet 311 into the casing 310 travels in a horizontal direction, and thereafter travels downward to pass through the heater 320. The air is thereby heated. The air having passed through the heater 320 travels in the horizontal direction to pass through the humidifying filter 330 in the lower portion in the casing 310.

The humidifying filter 330 includes a humidifying member supplied with water. The humidifying member is, for example, a non-woven cloth. The humidifying member may, for example, be a moisture permeable film type humidifying member using a porous moisture permeable film. The humidifying member is woven in a corrugated shape (cross sectional shape of corrugated cardboard) or a pleated shape (shape of an accordion) in order to increase a contact area with air.

In the present example, there is adopted a capillary tube type in which soaking of a part of the humidifying member into water leads to supply of water to the whole of the humidifying member due to a capillarity phenomenon. There may be adopted a dripping infiltration type in which dripping of water from the upper part of the humidifying member leads to supply of water to the whole of the humidifying member. Alternatively, there may be adopted a rotation type in which rotating of the humidifying member in the state where a part of the humidifying member is soaked in water leads to supply of water to the whole of the humidifying member.

By the air passing through the humidifying member of the humidifying filter 330, moisture is acquired from the humidifying member. The moisture of the air thereby increases. The air having passed through the humidifying filter 330 travels upward as humidified air, and is sent out by the turbo fan 340 to the hose 101 connected to the air flow outlet 312. A temperature measuring part 314 for measuring a temperature of the humidified air having passed through the humidifying filter 330 is arranged in the vicinity of the turbo fan 340.

A relative humidity measuring part for measuring a relative humidity of the humidified air having passed through the humidifying filter 330 may be provided in the vicinity of the temperature measuring part 314. Alternatively, it may be previously designed such that the relative humidity of the humidified air having passed through the humidifying filter 330 in the vicinity of the temperature measuring part 314 becomes approximately 90% to 95%. Based on the temperature and the relative humidity, it is possible to estimate an absolute humidity of the humidified air or a relative humidity of the humidified air at a predetermined temperature. Here, the absolute humidity in the present embodiment is a volume absolute humidity, which indicates a mass (g) of steam contained per unit volume (m³) of the air.

The electronic substrate 350 is mounted with a controller 351 including a CPU (Central Processing Unit) or the like that controls operations of the heater 320 and the turbo fan 340. Further, the electronic substrate 350 is provided with a power supply device 352 that supplies electric power to the heater 320, the turbo fan 340, the controller 351, and the like. The heat sink 360 is arranged on the electronic substrate 350. The heat sink 360 cools a heat generating component on the electronic substrate 350.

### (2) Static Elimination Head

### (a) First Example

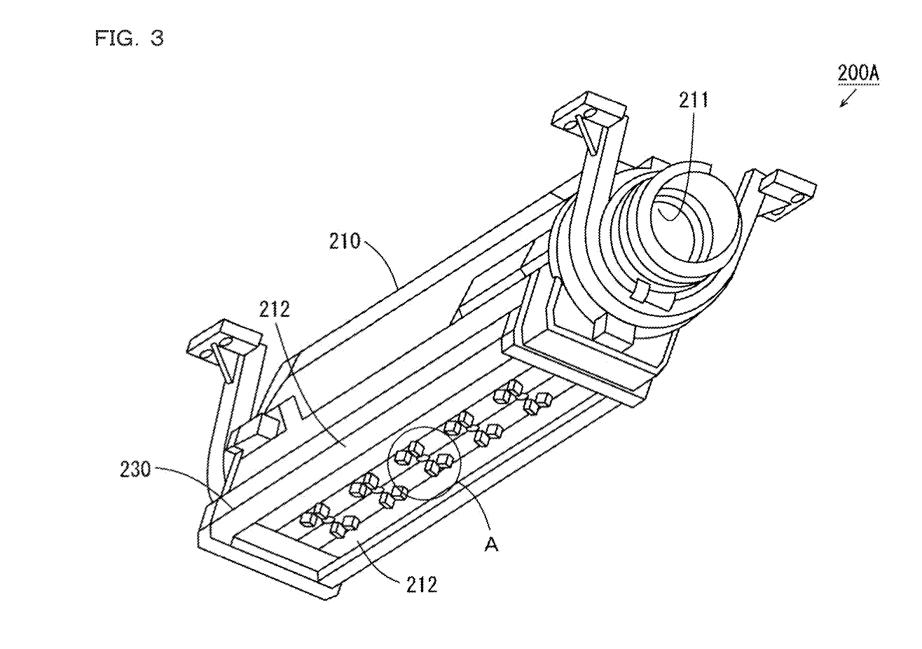

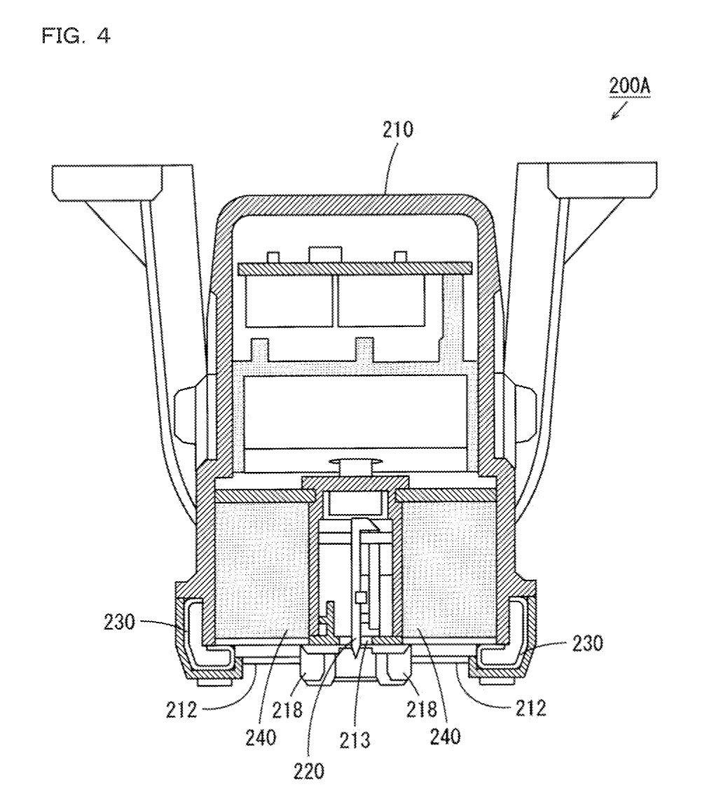

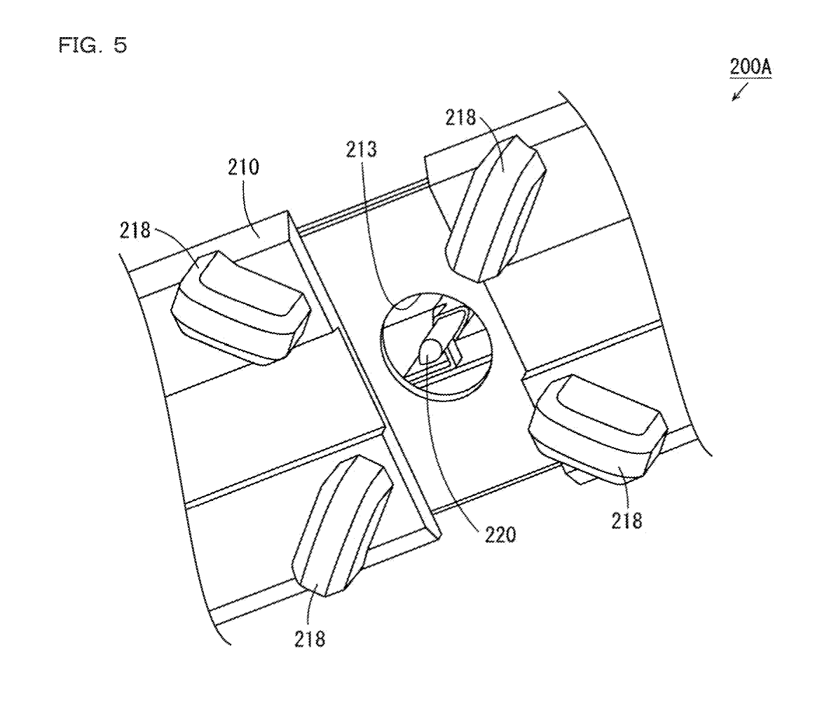

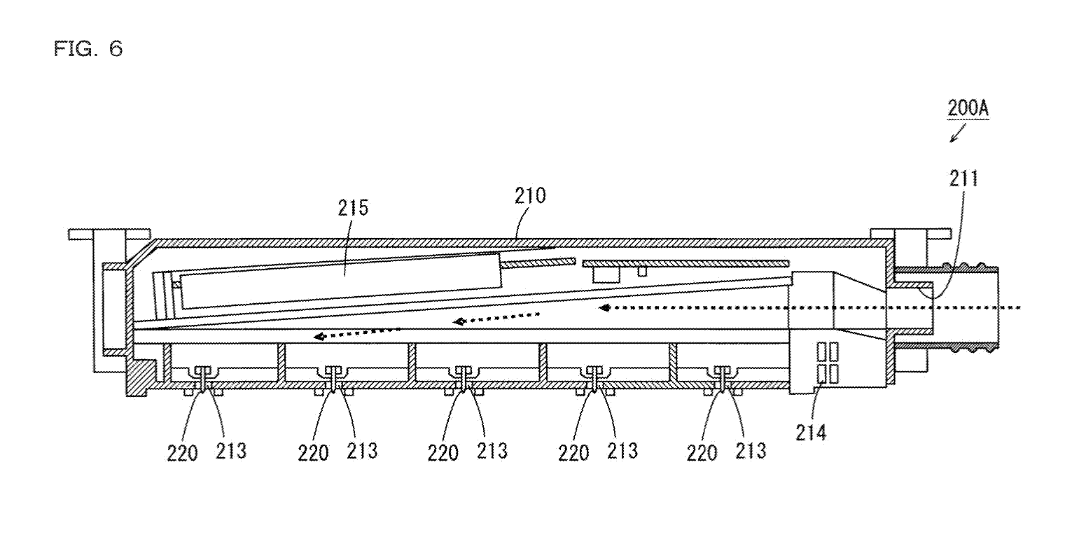

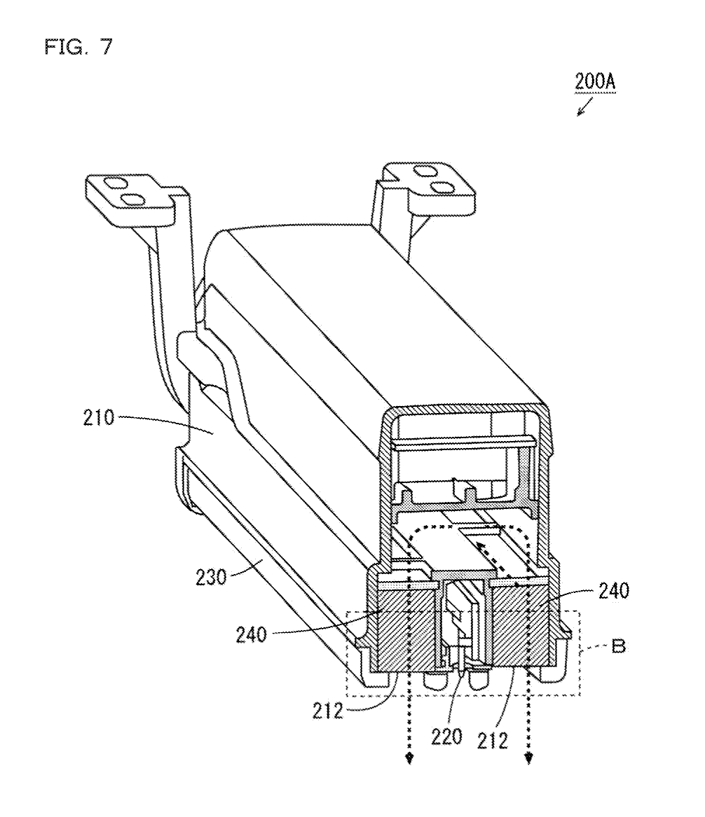

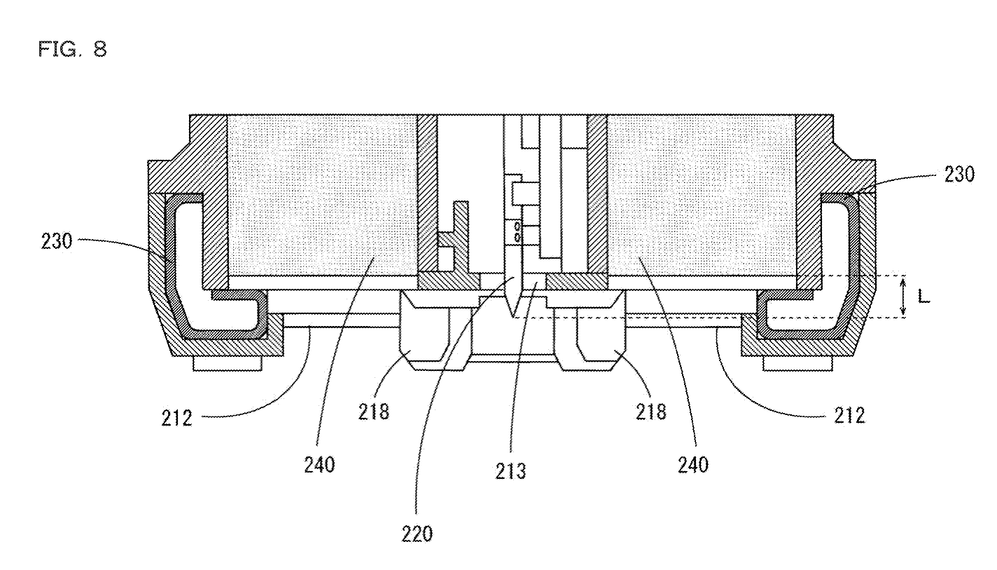

FIG. 3 is an external perspective view showing the static elimination head 200 in a first example. FIG. 4 is a vertical sectional view in a width direction of the static elimination head 200 of FIG. 3. FIG. 5 is an enlarged view of a part A of FIG. 3. FIG. 6 is a sectional view in a longitudinal direction of the static elimination head 200 of FIG. 3. FIG. 7 is a sectional perspective view in the width direction of the static elimination head 200 of FIG. 3. FIG. 8 is an enlarged sectional view of a part B of FIG. 7. Hereinafter, the static elimination head 200 in the first example of FIG. 3 is referred to as a static elimination head 200A.

As shown in FIGS. 3 to 6, the static elimination head 200A includes a casing 210, a plurality of static elimination needles 220 (FIG. 6), a pair of ground electrodes 230 (FIG. 4), and a plurality of rectifying plates 240 (FIGS. 4 and 6). The pair of ground electrodes 230 are electrically connected to each other. The casing 210 of the static elimination head 200A has a substantially rectangular shaped cross section, and extends in a longitudinal shape along one direction (longitudinal direction). A length in the longitudinal direction of the casing 210 is, for example, 400 mm. The length in the longitudinal direction of the casing 210 may, for example, be 700 mm, or may be 1000 mm. Alternatively, the length in the longitudinal direction of the casing 210 may be more than 1000 mm.

As shown in FIG. 3, an air flow inlet 211 for allowing humidified air to flow inside the casing 210 is formed at one end of the casing 210. On the lower surface of the casing 210, there are formed a pair of air flow outlets 212 for allowing humidified air inside the casing 210 to flow out. The air flow inlet 211 is provided on the one end surface in the longitudinal direction of the casing 210. The other end of the hose 101 of FIG. 1 is connected to the air flow inlet 211. Humidified air is allowed to flow from the humidified air generating part 300 into the casing 210 through the hose 101 of the air flow inlet 211. The flown-in humidified air is jetted from the air flow outlet 212 onto the static elimination object.

As shown in FIG. 6, a temperature measuring part 214 that measures a temperature of the humidified air in the casing 210 is provided inside the casing 210. The temperature measuring part 214 is arranged in a position not directly in contact with the humidified air but in contact with air outside the casing 210. Hence, it is possible to measure a temperature of the air outside the casing 210.

Further, a power supply device 215 is provided inside the casing 210. In a substantially central portion in the width direction of the lower surface of the casing 210, a plurality of (five in the example of FIG. 6) circular openings 213 are formed so as to be arranged along the longitudinal direction. A plurality of static elimination needles 220 are provided inside the casing 210 so as to be directed downward (to the outside of the casing 210).

As shown in FIG. 5, the static elimination needle 220 projects from each opening 213. A plurality of (four in the present example) projections 218 are provided around the opening 213. The lower surfaces of the plurality of projections 218 are located at positions below the tip of the static elimination needle 220. The plurality of projections 218 thereby have the function of protecting the static elimination needle 220. Even when the static elimination needle 220 collides with the static elimination object or another object, the plurality of projections 218 prevent a needlepoint of the static elimination needle 220 from being bent.

As shown in FIGS. 4 and 8, the ground electrodes 230 are provided in the lower portions of both side surfaces in the width direction of the casing 210 so as to extend in the longitudinal direction. The air flow outlets 212 are provided at both ends in the width direction of the casing 210 so as to extend along the longitudinal direction. Therefore, one air flow outlet 212 is located between the one ground electrode 230 and the plurality of static elimination needles 220, and the other air flow outlet 212 is located between the other ground electrode 230 and the plurality of static elimination needles 220. A plurality of planar rectifying plates 240 are arranged at each air flow outlet 212.

A gap between two adjacent projections 218 is located on a straight line connecting the static elimination needle 220 and the ground electrodes 230. In this case, since an obstacle is not arranged between the needlepoint of the static elimination needle 220 and the ground electrode 230, corona discharge can be efficiently generated between the static elimination needle 220 and the ground electrode 230.

As indicated by arrows in FIGS. 6 and 7, the humidified air having flown in from the air flow inlet 211 travels in the longitudinal direction, and is allowed to flow out of the air flow outlet 212 while being rectified downward by the rectifying plate 240. The rectifying plate 240 suppresses diffusion of the humidified air, jetted from the air flow outlet 212, in the air around the casing 210. Hence, the static elimination head 200 can jet the humidified air to a farther distance.

As shown in FIG. 8, each static elimination needle 220 is arranged so as to project more than each rectifying plate 240 only by a distance L in a flow-out direction of the humidified air (downward in the present example). A high voltage is applied between the plurality of static elimination needles 220 and the ground electrode 230 by the power supply device 215 in the casing 210 of FIG. 6. Thereby, corona discharge is generated between the plurality of static elimination needles 220 and the ground electrode 230. Ions are generated by the corona discharge. The generated ions are sent out by the humidified air flowing out of the air flow outlet 212, and jetted onto the static elimination object.

In this manner, in the static elimination head 200A, the ions generated between the one ground electrode 230 and the plurality of static elimination needles 220 are sent out by the humidified air that is allowed to flow out of the one air flow outlet 212. Further, the ions generated between the other ground electrode 230 and the plurality of static elimination needles 220 are sent out by the humidified air that is allowed to flow out of the other air flow outlet 212.

According to this configuration, the ions generated on both sides of the plurality of static elimination needles 220 are efficiently sent out by the humidified air. Therefore, with static electricity being eliminated over a wide range, the static elimination head 200A is suitable for eliminating static electricity on a wide static elimination object or a linear static elimination object (e.g., paper, film, or glass), for example.

### (b) Second Example

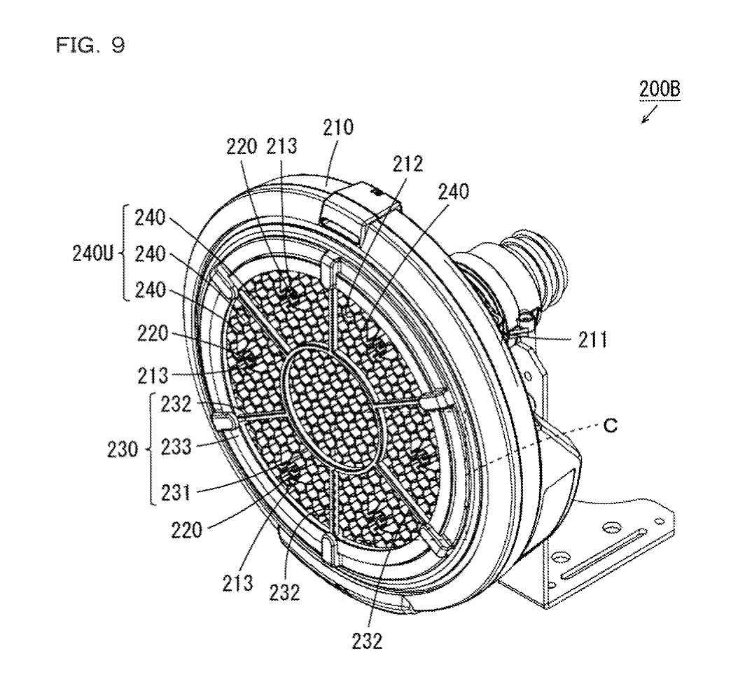

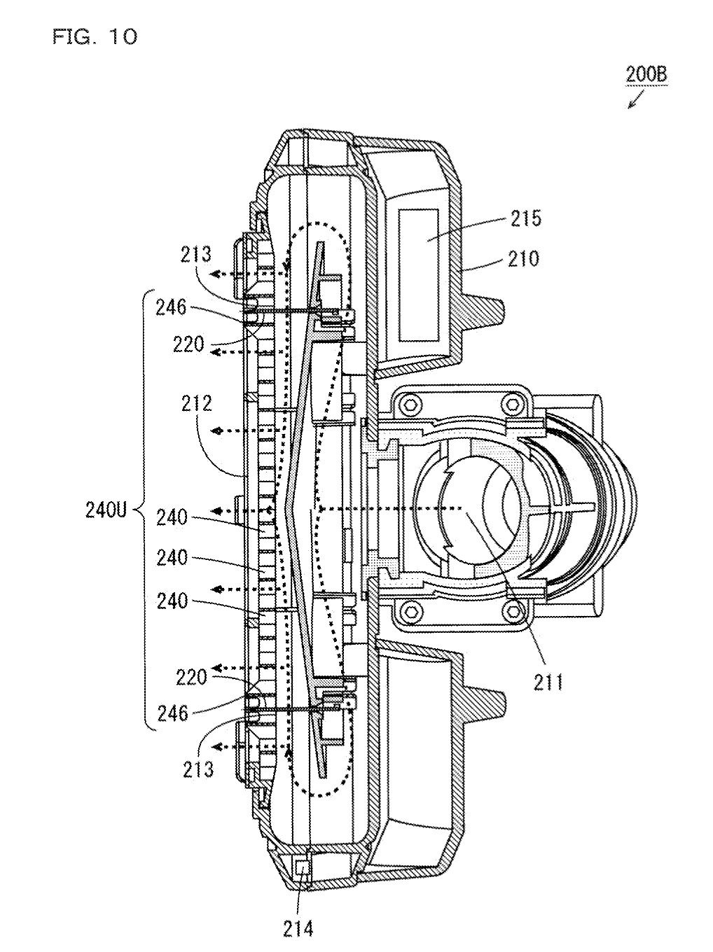

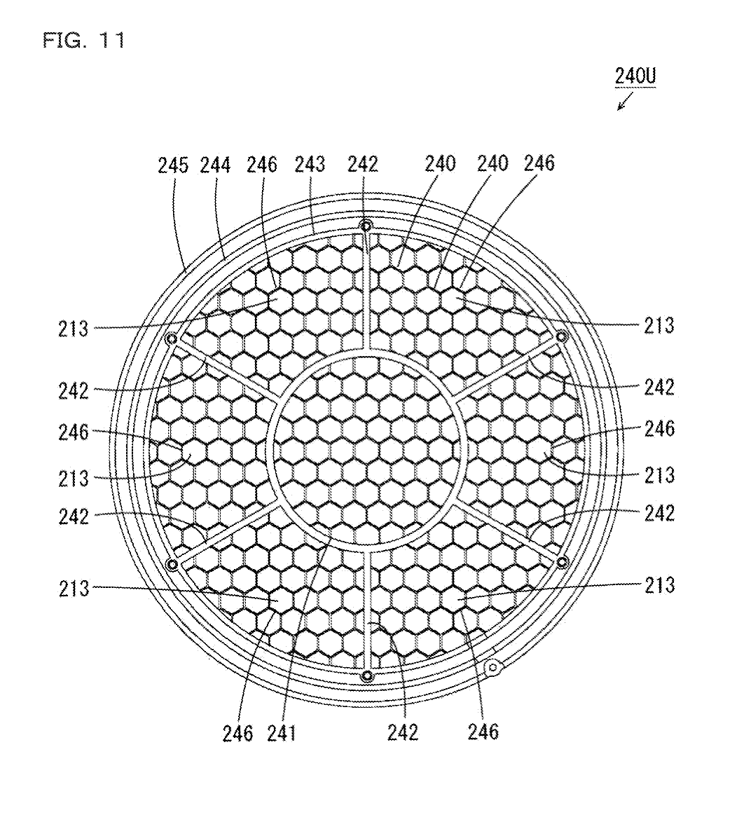

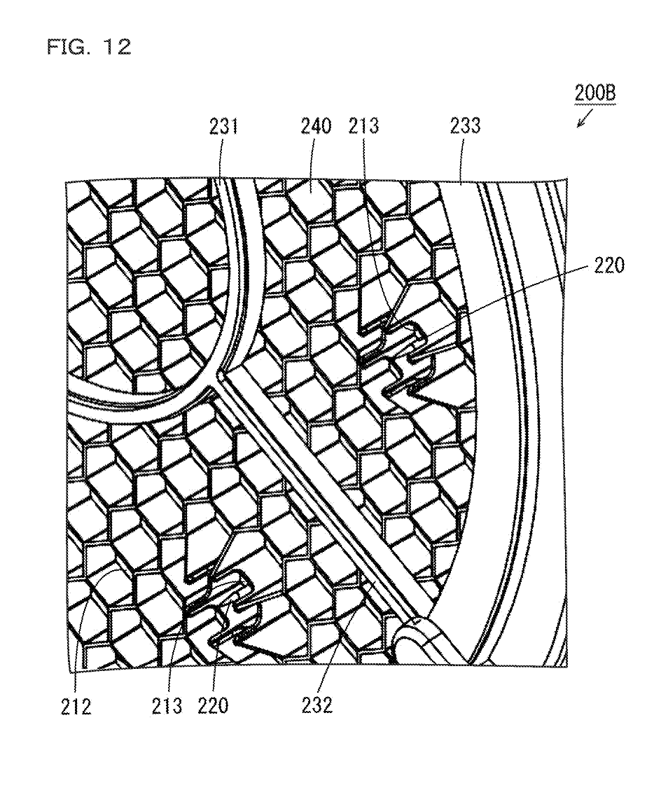

FIG. 9 is an external perspective view showing a static elimination head 200 in a second example. FIG. 10 is a vertical sectional view of the static elimination head 200 of FIG. 9. FIG. 11 is a front view of a rectifying plate unit of the static elimination head 200 of FIG. 9. FIG. 12 is an enlarged view of a part C of FIG. 9. Hereinafter, the static elimination head 200 in the second example of FIG. 9 is referred to as a static elimination head 200B.

As shown in FIG. 9, a casing 210 of the static elimination head 200B has a substantially disk shape. An air flow inlet 211 is provided on one surface (rear surface) of the casing 210. A plurality of air flow outlets 212 are provided on the other surface (front surface). As shown in FIG. 10, a temperature measuring part 214 that measures a temperature of air outside the casing 210 is provided inside the casing 210. The temperature measuring part 214 is arranged in a position not directly in contact with the humidified air but in contact with air outside the casing 210. Hence, it is possible to measure a temperature of the air outside the casing 210. Further, a power supply device 215 is provided inside the casing 210.

As shown in FIG. 9, the plurality of static elimination needles 220 are provided inside the casing 210 so as to be directed forward at intervals of a substantially equal angle. In the present example, six static elimination needles 220 are arranged at intervals of about 60°. Further, a ground electrode 230 is arranged on the front surface of the casing 210. The ground electrode 230 includes an internal electrode 231, a plurality of connection electrodes 232, and an external electrode 233.

The internal electrode 231 is an electrode having an annular shape surrounding a substantially center of the front surface of the casing 210. The external electrode 233 is an electrode having an annular shape concentric to the internal electrode 231 and surrounding the internal electrode 231. The plurality of connection electrodes 232 electrically connect the internal electrode 231 and the external electrode 233. In the present example, six connection electrodes 232 are arranged at intervals of about 60°.

As shown in FIG. 11, a rectifying plate unit 240U including a plurality of rectifying plates 240 is provided in the static elimination head 200B. In addition to the plurality of rectifying plates 240, the rectifying plate unit 240U includes a holding member 241, a plurality of holding members 242, holding members 243, 244, 245, and a plurality of barrier ribs 246.

The plurality of rectifying plates 240 and the plurality of barrier ribs 246 are integrally formed. The plurality of rectifying plates 240 and the plurality of barrier ribs 246 are arranged so as to form a honeycomb structure made of a plurality of hexagons. The inside of each hexagon formed by the plurality of barrier ribs 246 becomes an opening 213.

The holding members 241, 243, to 245 have annular shapes, and are concentrically formed in this order from the inner side. The plurality of holding members 242 connect the holding member 241 and the holding member 243. In the present example, six holding members 242 are arranged at intervals of about 60°. In the present example, the plurality of openings 213 are respectively arranged in a plurality of regions each surrounded by the holding member 241, two adjacent holding members 242, and the holding member 243.

The holding members 244, 245 are fixed to the casing 210 of FIG. 9. Thereby, the rectifying plate unit 240U is fixed to the casing 210. In a state where the rectifying plate unit 240U is fixed to the casing 210, the internal electrode 231 of FIG. 9 is located on the holding member 241. The plurality of connection electrodes 232 of FIG. 9 are respectively located on the plurality of holding members 242. The external electrode 233 of FIG. 9 is located on the holding members 243 to 245.

According to this configuration, as shown in FIG. 12, each static elimination needle 220 is surrounded by the plurality of barrier ribs 246. Thereby, the plurality of static elimination needles 220 project respectively from the plurality of openings 213. Further, each static elimination needle 220 is surrounded by the internal electrode 231, the connection electrodes 232, and the external electrode 233.

As indicated by arrows in FIG. 10, humidified air having flown in from the air flow inlet 211 is allowed to flow out of the air flow outlet 212 while being rectified in one direction by the rectifying plate 240. In the present example, the humidified air is also allowed to flow out of the opening 213 where the static elimination needle 220 exists. Therefore, each static elimination needle 220 is located in the humidified air that is allowed to flow out of the air flow outlet 212. Each static elimination needle 220 is arranged so as to project more than each rectifying plate 240 only by a distance L in a flow-out direction of the humidified air (forward in the present example).

A high voltage is applied between the plurality of static elimination needles 220 and the ground electrode 230 by a power supply device 215 in the casing 210. Thereby, corona discharge is generated between the plurality of static elimination needles 220 and the ground electrode 230. Ions are generated by the corona discharge. The generated ions are sent out by the humidified air flowing out of the plurality of air flow outlets 212, and jetted onto the static elimination object.

In the present example, a notch is formed in a part of the plurality of barrier ribs 246 surrounding each static elimination needle 220 so as to reduce the obstacle between a needlepoint of each static elimination needle 220 and the ground electrode 230. Hence, it is possible to efficiently generate corona discharge between the plurality of static elimination needles 220 and the ground electrode 230 while protecting the static elimination needles 220 by the plurality of barrier ribs 246.

In this manner, in the static elimination head 200B, the plurality of static elimination needles 220 are provided so as to be located in the humidified air that is allowed to flow out of the air flow outlet 212. Thereby, the ions generated around each static elimination needle 220 are efficiently sent out by the humidified air. According to this configuration, it is possible to provide a relatively large number of static elimination needles 220 in the casing 210. Therefore, since static electricity is eliminated over a wide range, the static elimination head 200B is suitable for eliminating static electricity on a static elimination object in cell manufacturing or a small-sized component on a parts feeder, for example.

### (c) Third Example

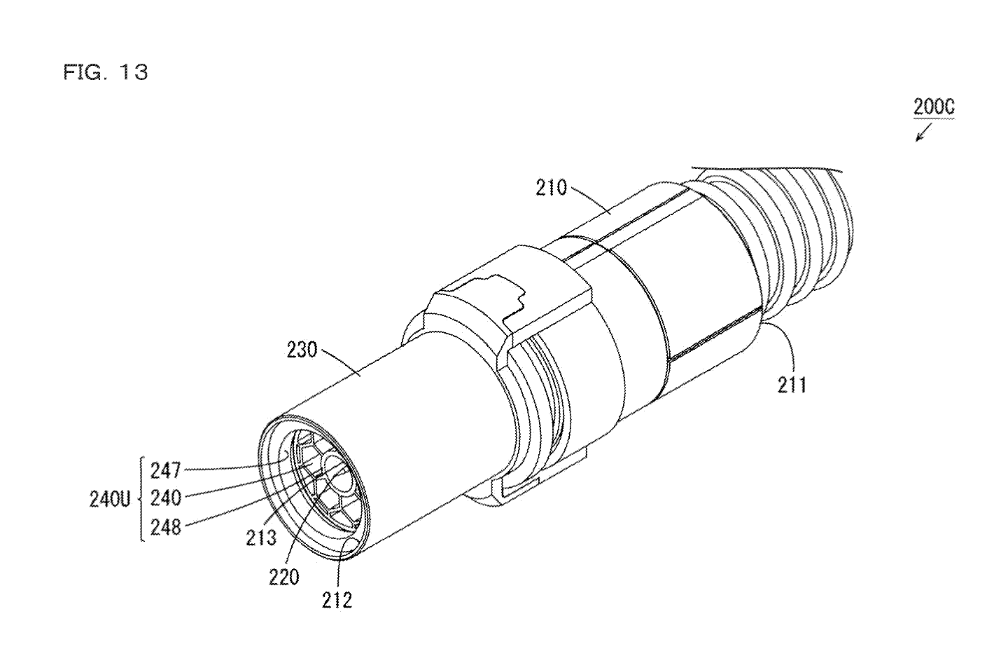

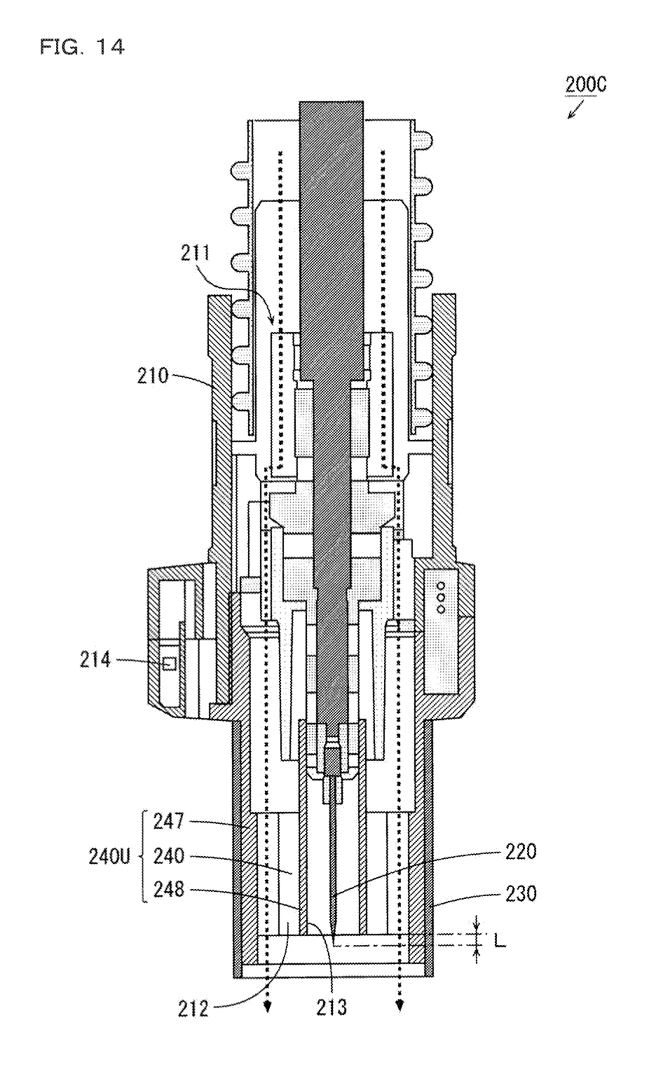

FIG. 13 is an external perspective view showing a static elimination head 200 in a third example. FIG. 14 is a vertical sectional view of the static elimination head 200 of FIG. 13. Hereinafter, the static elimination head 200 in the third example of FIG. 13 is referred to as a static elimination head 200C.

As shown in FIGS. 13 and 14, a casing 210 of the static elimination head 200C has a substantially cylindrical shape. An air flow inlet 211 is provided at one end (hereinafter referred to as rear end) of the casing 210, and an air flow outlet 212 is provided at the other end (hereinafter referred to as front end). A static elimination needle 220 is provided inside the casing 210 so as to be directed to the front end. As shown in FIG. 14, a temperature measuring part 214 that measures a temperature of air outside the casing 210 is provided inside the casing 210. The temperature measuring part 214 is arranged in a position not directly in contact with the humidified air but in contact with air outside the casing 210. Hence, it is possible to measure a temperature of the air outside the casing 210. Note that, in the present example, a power supply device is not provided inside the casing 210.

A rectifying plate unit 240U including a plurality of rectifying plates 240 is provided at the front end of the casing 210. The rectifying plate unit 240U includes a casing 247 and a barrier rib 248 in addition to the plurality of rectifying plates 240.

The plurality of rectifying plates 240 and the barrier rib 248 are integrally formed. The barrier rib 248 has a cylindrical shape. The inside of the barrier rib 248 becomes an opening 213. The plurality of rectifying plates 240 are arranged so as to surround the barrier rib 248 and form a honeycomb structure. The casing 247 has a cylindrical shape. The plurality of rectifying plates 240 and the barrier rib 248 are held inside the casing 247.

The casing 247 is fixed to the casing 210. Thereby, the rectifying plate unit 240U is fixed to the casing 210. The static elimination needle 220 is surrounded by the barrier rib 248 in a state where the rectifying plate unit 240U is fixed to the casing 210. Thereby, the static elimination needle 220 projects from the opening 213. A ground electrode 230 having a cylindrical shape is fitted to the outer peripheral surface of the casing 247 of the rectifying plate unit 240U. The air flow outlet 212 is located in an annular region between the barrier rib 248 and the ground electrode 230.

As indicated by arrows in FIG. 14, humidified air having flown in from the air flow inlet 211 is allowed to flow out of the air flow outlet 212 while being rectified in one direction by the rectifying plate 240. The static elimination needle 220 is arranged so as to project more than each rectifying plate 240 only by a distance L in a flow-out direction of the humidified air (toward the front end in the present example).

In the static elimination head 200C, a high voltage is applied between the static elimination needle 220 and the ground electrode 230 by a high-voltage power supply (not shown) of the humidified air generating part 300 of FIG. 2. Thereby, corona discharge is generated between the static elimination needle 220 and the ground electrode 230. Ions are generated by the corona discharge. The generated ions are sent out by the humidified air flowing out of the plurality of air flow outlets 212, and jetted onto the static elimination object.

In this manner, in the static elimination head 200C, the ground electrode 230 is formed so as to annularly surround the periphery of the static elimination needle 220, and the air flow outlet 212 allows the humidified air to flow out to the annular region between the static elimination needle 220 and the ground electrode 230. Thereby, the ions generated around the static elimination needle 220 are efficiently sent out by the humidified air. According to this configuration, the casing 210 is formed narrow. Hence, since static electricity is eliminated in a limited narrow range, the static elimination head 200C is suitable for eliminating static electricity on an ejection-molded component or a small-sized component such as an electronic component, for example.

### (3) Temperature Control Process for Humidified Air

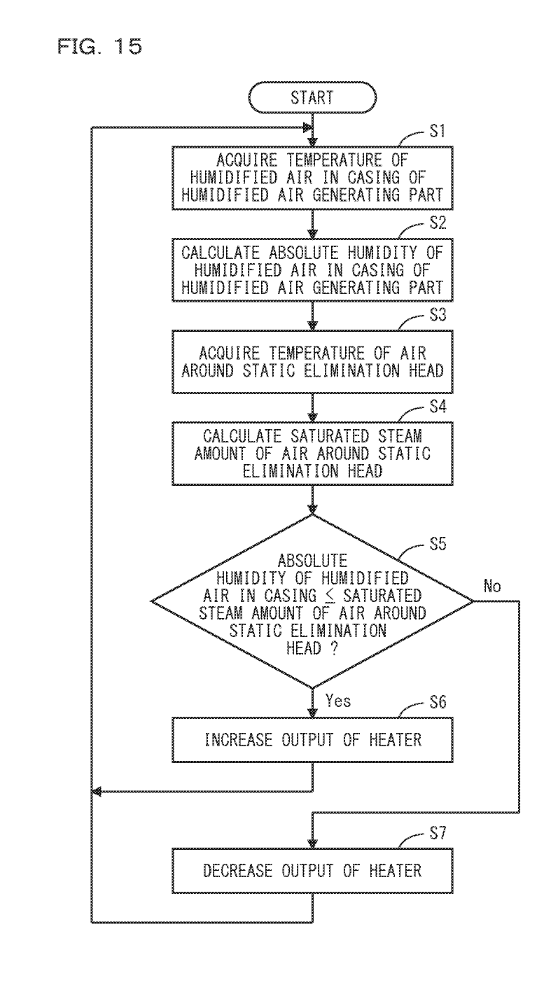

The controller 351 of the humidified air generating part 300 of FIG. 2 executes a temperature control process for humidified air so as not to cause condensation on the static elimination object due to the humidified air jetted from the static elimination head 200. FIG. 15 is a flowchart showing the temperature control process for humidified air by the controller 351.

The controller 351 acquires a temperature of humidified air in the casing 310 of the humidified air generating part 300 from the temperature measuring part 314 of FIG. 2 (Step S1). Note that the temperature measuring part 314 is provided in the vicinity of the turbo fan 340. Therefore, the temperature acquired by the temperature measuring part 314 is a temperature of humidified air in the vicinity of the turbo fan 340.

In the present example, it has been previously set such that a relative humidity of the humidified air having passed through the humidifying filter 330 of FIG. 2 becomes approximately 90% to 95%. The controller 351 calculates an absolute humidity of the humidified air in the casing 310 of the humidified air generating part 300 based on the previously set relative humidity and the temperature acquired from the temperature measuring part 314 (Step S2).

Next, the controller 351 acquires a temperature of air around the static elimination head 200 from the temperature measuring part 214 of FIG. 6, 10, or 14 (Step S3). The display part 313 may be configured such that a temperature around the static elimination head 200 can be inputted thereinto by the user. In this case, the temperature measuring part 214 may not be provided in the static elimination head 200. The controller 351 can acquire the inputted temperature of air around the static elimination head 200 from the display part 313. Subsequently, the controller 351 calculates a saturated steam amount of the air around the static elimination head 200 based on the temperature acquired from the temperature measuring part 214 or the display part 313 (Step S4).

Subsequently, the controller 351 determines whether or not the calculated absolute humidity of the humidified air in the casing 210 of the static elimination head 200 is equal to or lower than the saturated steam amount of the air around the static elimination head 200 (Step S5). In Step S5, when the absolute humidity of the humidified air in the casing 210 of the static elimination head 200 is equal to or lower than the saturated steam amount of the air around the static elimination head 200, the controller 351 increases an output of the heater 320 (Step S6). Thereafter, the controller 351 returns to the process of Step S1.

On the other hand, in Step S5, when the absolute humidity of the humidified air in the casing 210 of the static elimination head 200 exceeds the saturated steam amount of the air around the static elimination head 200, the controller 351 decreases the output of the heater 320 (Step S7). Thereafter, the controller 351 returns to the process of Step S1. By repeating the above procedure, it is possible to eliminate static electricity on the static elimination object without causing condensation on the static elimination object.

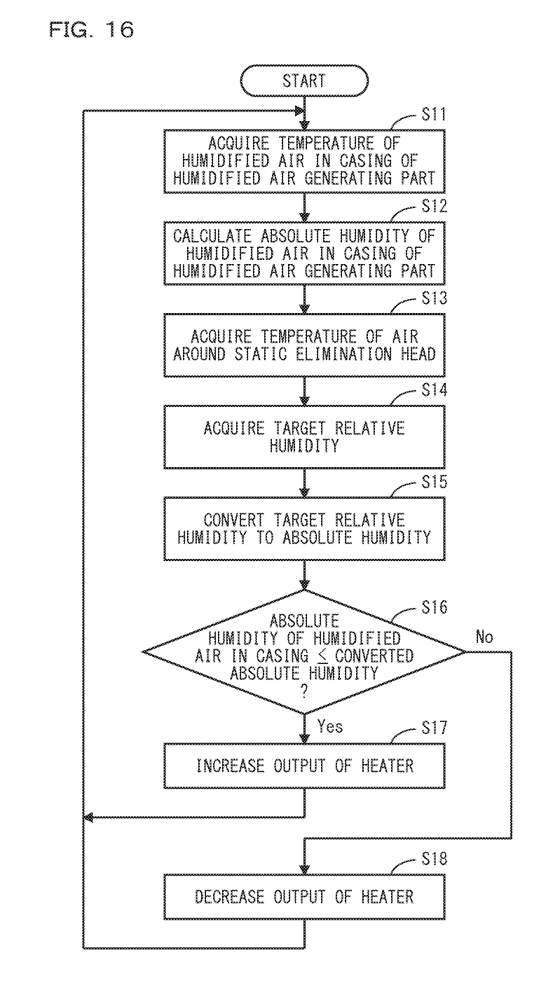

FIG. 16 is a flowchart showing another example of the temperature control process for humidified air by the controller 351. The processes of Steps S11 to S13 of FIG. 16 are similar to the processes of Steps S1 to S3 of FIG. 15.

After the process of Step S13, the controller 351 acquires a target relative humidity from the display part 313 of FIG. 1 (Step S14). The target relative humidity may be a target value of the relative humidity of the air around the object, or may simply be a target value of the relative humidity at the time when the humidified air jetted from the static elimination head 200 has the temperature of the air around the static elimination head 200. Alternatively, the target relative humidity may be previously stored in a memory (not shown) which is mounted on the electronic substrate 350 of FIG. 2. Next, the controller 351 converts the target relative humidity to an absolute humidity based on the temperature acquired from the temperature measuring part 214 or the display part 313 (Step S15).

Subsequently, the controller 351 determines whether or not the calculated absolute humidity of the humidified air in the casing 210 of the static elimination head 200 is equal to or lower than the converted absolute humidity (Step S16). In Step S16, when the absolute humidity of the humidified air in the casing 210 of the static elimination head 200 is equal to or lower than the converted absolute humidity, the controller 351 increases the output of the heater 320 (Step S17). Thereafter, the controller 351 returns to the process of Step S11.

On the other hand, in Step S16, when the absolute humidity of the humidified air in the casing 210 of the static elimination head 200 exceeds the converted absolute humidity, the controller 351 decreases the output of the heater 320 (Step S18). Thereafter, the controller 351 returns to the process of Step S11. By repeating the above procedure, it is possible to eliminate static electricity on the static elimination object without causing condensation on the static elimination object.

In place of the process of Step S15, the relative humidity of the air around the static elimination head 200 may be calculated based on the absolute humidity of the humidified air in the casing 310 of the humidified air generating part 300 and the temperature acquired by the temperature measuring part 214 or the display part 313. In this case, in the process of Step S16, it is determined whether or not the calculated relative humidity of the air around the static elimination object is equal to or lower than the target relative humidity.

When the calculated relative humidity of the air around the static elimination object is equal to or lower than the target relative humidity, the output of the heater 320 is increased. On the other hand, when the calculated relative humidity of the air around the static elimination object exceeds the target relative humidity, the output of the heater 320 is decreased.

As another function of the controller 351, the controller 351 controls the heater 320 such that the temperature measured by the temperature measuring part 314 becomes the temperature acquired by the temperature measuring part 214 or the display part 313. The control of the heater 320 in this process, the control of the heater 320 in the process of FIG. 15, and the control of the heater 320 in the process of FIG. 16 may be performed by the single controller 351, or may be respectively performed by separate controllers.

As yet another function of the controller 351, the controller 351 may have the function of performing feedback control of ion balance by measuring an ion current. Further, the controller 351 may have the function of detecting an amount of ions, or the function of outputting an alarm in the case where an abnormal discharge occurs.

### (4) Effect

In the static eliminator 100 according to the present embodiment, humidified air generated by the humidified air generating part 300 is allowed to flow out of the air flow outlet 212 of the static elimination head 200. The one or the plurality of static elimination needles 220 and the ground electrode 230 are held in the static elimination head 200. A high voltage for generating corona discharge is applied between the one or the plurality of static elimination needles 220 and the ground electrode 230.

The one or the plurality of static elimination needles 220 are arranged in the static elimination head 200 such that ions generated by the corona discharge are sent out by the humidified air. According to this configuration, static electricity on the static elimination object is eliminated by supplying the humidified air to the static elimination object, and static electricity on static elimination object is further eliminated by supplying the ions to the static elimination object. Moreover, the static elimination effect is improved as compared to the case where the ions are sent out by low-humidity air. Furthermore, even in a low-humidity environment, it is possible to obtain the static elimination effect to a certain extent or more. This enables sufficient elimination of static electricity on the static elimination object irrespective of a surrounding environment.

Further, in the present embodiment, the humidified air generated by the humidified air generating part 300 is led to the static elimination head 200 by the hose 101. Hence, it is possible to separate the static elimination head 200 from the humidified air generating part 300. This facilitates the one or the plurality of static elimination needles 220 of the static elimination head 200 to be arranged in the vicinity of the static elimination object. As a result, it is possible to improve the static elimination efficiency.

Further, in the present embodiment, it is possible to select each of the static elimination heads 200A to 200C connected to the humidified air generating part 300 in accordance with the use and the shape of the static elimination object. The number of static elimination needles 220 of the static elimination head 200C is smaller than the number of static elimination needles 220 of each of the static elimination heads 200A, 200B. Further, since the static elimination head 200C may not include the power supply device inside thereof, it can be made smaller in size than the static elimination heads 200A, 200B.

Accordingly, the use of the static elimination heads 200A, 200B can facilitate elimination of static electricity in a relatively large range or on a relatively large-sized static elimination object, and the use of the static elimination head 200C can facilitate elimination of static electricity in a relatively narrow range or on a relatively small-sized static elimination object.

In the present embodiment, any of the plurality of static elimination heads 200 is detachably attached to the humidified air generating part 300, but the present invention is not limited thereto. Two or more static elimination heads 200 may be attached to the humidified air generating part 300.

### [2] Second Embodiment

### (1) Configuration of Static Eliminator

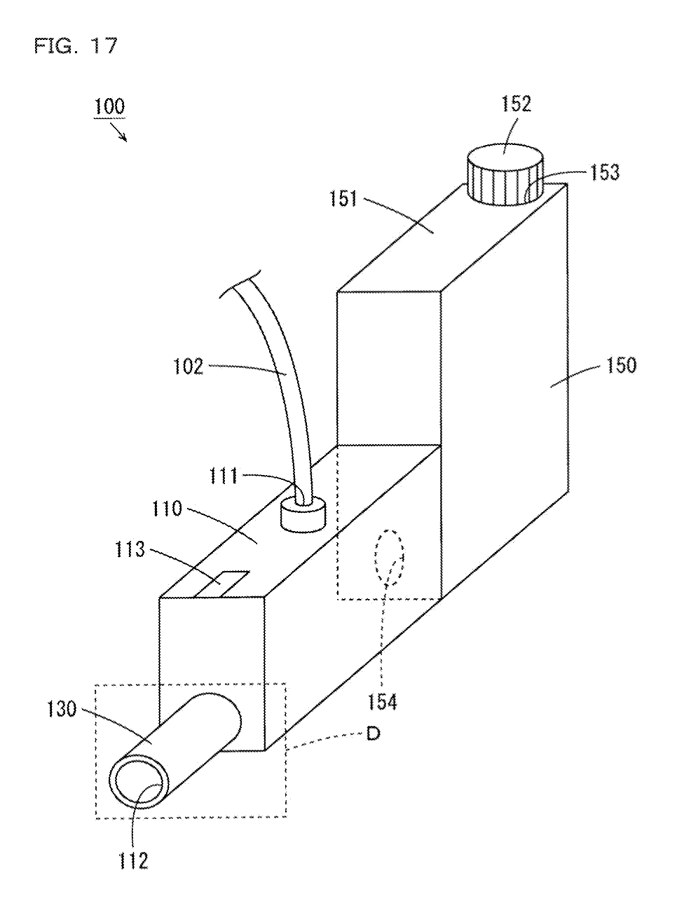

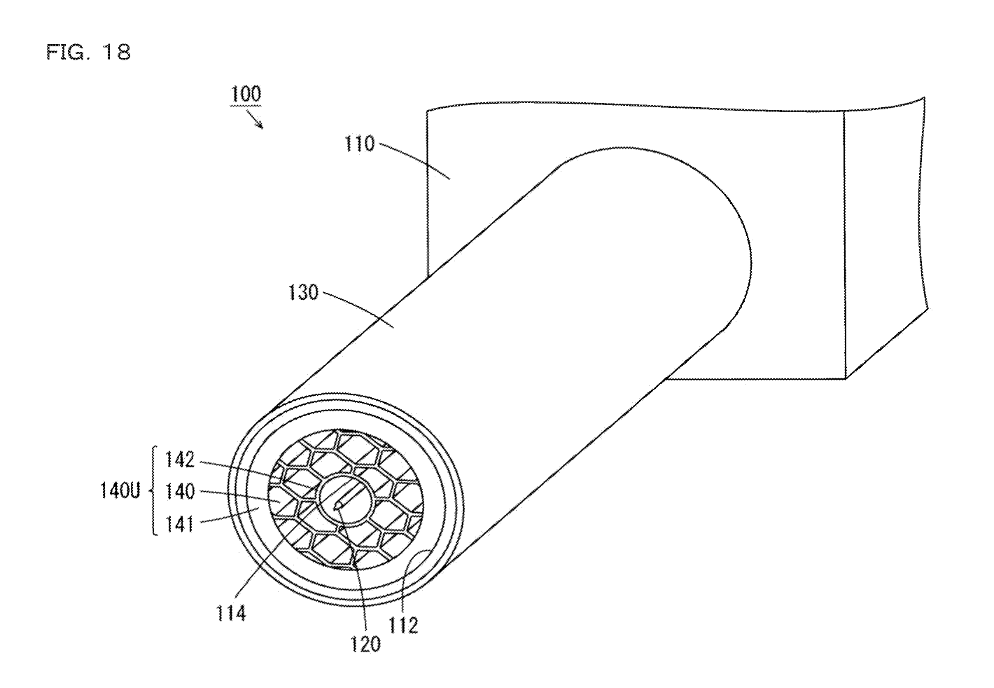

A point in which a static eliminator according to a second embodiment is different from the static eliminator 100 according to the first embodiment will be described. FIG. 17 is a schematic external perspective view of a static eliminator according to a second embodiment. FIG. 18 is an enlarged view of a part D of FIG. 17.

As shown in FIGS. 17 and 18, a static eliminator 100 according to the present embodiment includes a casing 110, a static elimination needle 120, a ground electrode 130, a rectifying plate 140, and a water supply part 150. The static elimination needle 120, the ground electrode 130, and the rectifying plate 140 respectively have similar configurations and functions to those of the static elimination needle 220, the ground electrode 230, and the rectifying plate 240 of FIG. 13.

The casing 110 has a substantially rectangular parallelepiped shape. A heater, a humidifying filter, and an electronic substrate respectively similar to the heater 320, the humidifying filter 330, and the electronic substrate 350 of FIG. 2 are provided in the casing 110. Further, a temperature measuring part (not shown) is provided in the casing 110. A controller mounted on the electronic substrate in the casing 110 can execute a temperature control process for humidified air which is similar to that in FIG. 15 based on a temperature acquired by the temperature measuring part.

The water supply part 150 is arranged so as to be adjacent to the casing 110 on its one end surface. The water supply part 150 is a water storage tank, for example, and includes a container 151 and a lid 152. The water supply part 150 may be a pet bottle, for example. Alternatively, the water supply part 150 may be directly connected to a water pipe.

An injection port 153 and a discharge port 154 are formed in the container 151. Water is injected from the injection port 153 into the container 151, and the water is housed in the container 151. The lid 152 is attached to the container 151 such that the injection port 153 of the container 151 can be blocked. The water housed in the container 151 is supplied from the discharge port 154 into the adjacent casing 110.

A display part 113 similar to the display part 313 of FIG. 1 is provided on the top surface of the casing 110. Further, an air flow inlet 111 for supplying compressed air into the casing 110 is formed on the top surface of the casing 110. A compressed air pipe 102 is connected to the air flow inlet 111. Note that, when a small-sized fan for taking air into the casing 110 is provided, the compressed air pipe 102 may not be connected to the air flow inlet 111.

As shown in FIG. 18, a rectifying plate unit 140U having a cylindrical shape is provided so as to project from the other end surface of the casing 110. An air flow outlet 112 is provided at one end of the rectifying plate unit 140U. The rectifying plate unit 140U includes a plurality of rectifying plates 140, a casing 141, and a barrier rib 142.

The plurality of rectifying plates 140 and the barrier rib 142 are integrally formed. The barrier rib 142 has a cylindrical shape. An opening 114 is formed inside the barrier rib 142. The plurality of rectifying plates 140 are arranged so as to surround the barrier rib 142 and form a honeycomb structure. The casing 141 has a cylindrical shape. The plurality of rectifying plates 140 and the barrier rib 142 are held inside the casing 141.

The casing 141 is fixed to the casing 110. Thereby, the rectifying plate unit 140U is fixed to the casing 110. The static elimination needle 120 is surrounded by the barrier rib 142 in a state where the rectifying plate unit 140U is fixed to the casing 110. Thereby, the static elimination needle 120 projects from the opening 114. The ground electrode 130 having a cylindrical shape is fitted onto the outer peripheral surface of the casing 141. The air flow outlet 112 is located in an annular region between the barrier rib 142 and the ground electrode 130.

Air having flown in from the air flow inlet 111 is humidified in the casing 110, and the flown-in air is allowed to flow out of the air flow outlet 112 as humidified air while being rectified in one direction by the rectifying plate 140. The static elimination needle 120 is arranged so as to project more than each rectifying plate 140 only by a distance L in a flow-out direction of the humidified air.

A high voltage is applied between the static elimination needle 120 and the ground electrode 130 by a power supply device mounted on the electronic substrate (not shown) in the casing 110. Thereby, corona discharge is generated between the static elimination needle 120 and the ground electrode 130. Ions are generated by the corona discharge. The generated ions are sent out by the humidified air flowing out of the plurality of air flow outlets 112, and jetted onto the static elimination object.

The power supply device is preferably a high-frequency AC power supply device. In this case, the static eliminator 100 can be reduced in size. Alternatively, when a positive electrode static elimination needle 120 and a negative electrode static elimination needle 120 are provided in the casing 110, the power supply device may be a DC power supply device. Even in this case, the static eliminator 100 can be reduced in size while the ion balance is favorably kept.

Similarly to the first embodiment, the controller mounted on the electronic substrate (not shown) in the casing 110 may have the function of performing feedback control of the ion balance by measuring an ion current. Further, the controller may have the function of detecting an amount of ions, or the function of outputting an alarm in the case where an abnormal discharge occurs.

### (2) Effect

Also in the present embodiment, similarly to the first embodiment, static electricity on static elimination object is eliminated by supplying the humidified air to the static elimination object, and static electricity on static elimination object is further eliminated by supplying the ions to the static elimination object. Moreover, the static elimination effect is improved as compared to the case where the ions are sent out by low-humidity air. Furthermore, even in a low-humidity environment, it is possible to obtain the static elimination effect to a certain extent or more. This enables sufficient elimination of static electricity on the static elimination object irrespective of a surrounding environment.

Moreover, in the present embodiment, the air flow outlet 112, at least a part of the one or the plurality of static elimination needles 120, and the humidifying filter 330 are integrally provided in the casings 110, 141. Hence, it is possible to simplify the configuration of the static eliminator 100, and make the static eliminator 100 compact and lightweight.

### [3] Other Embodiments

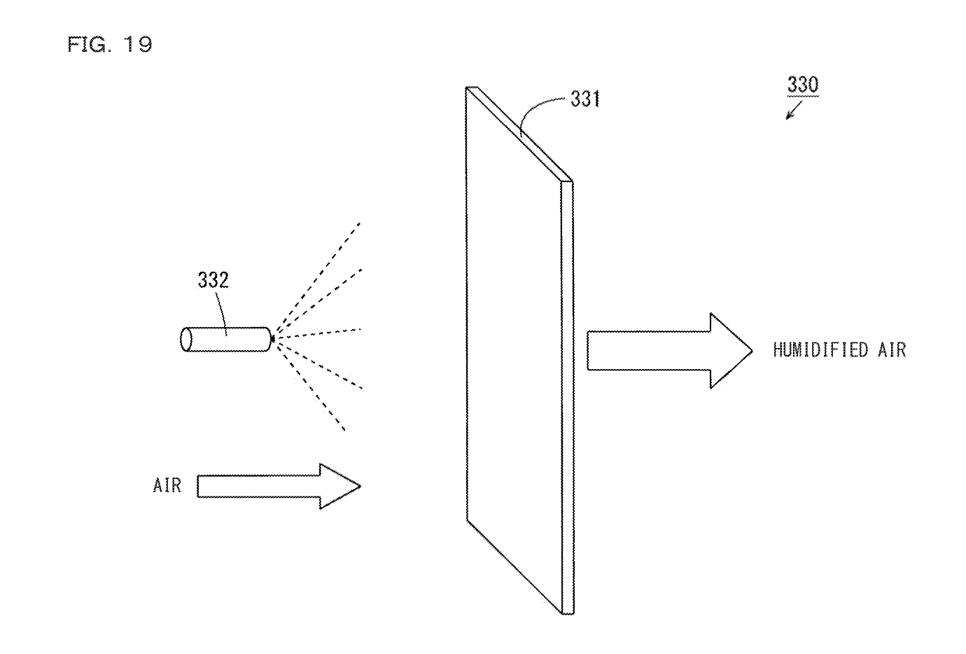

(1) In the first and second embodiments, the humidifying filter 330 is a vaporization-type humidifying filter, but the present invention is not limited thereto. The humidifying filter 330 may be a humidifying filter of another type. FIG. 19 is a schematic view showing a configuration of a humidifying filter 330 of another type.

The humidifying filter 330 of FIG. 19 includes a filtering part 331 and a humidifying part 332. The filtering part 331 is a filtering member capable of transmitting air and removing water drops. The humidifying part 332 is, for example, a spray, and supplies water drops to the filtering part 331. As indicated by arrows in FIG. 19, air is humidified by passing through the filtering part 331, to become humidified air.

(2) The power supply device 215 is provided inside the casing 210 of each of the static elimination heads 200A, 200B in the first embodiment, but the present invention is not limited thereto. The power supply device 215 may not be provided inside the casing 210 of each of the static elimination heads 200A, 200B. In this case, a high voltage is applied between the static elimination needle 220 and the ground electrode 230 by a high-voltage power supply (not shown) of the humidified air generating part 300.

Further, the power supply device is not provided inside the casing 210 of the static elimination head 200C, but the present invention is not limited thereto. When there is enough space inside the casing 210 of the static elimination head 200C, the power supply device may be provided inside the casing 210. In this case, a high voltage is applied between the static elimination needle 220 and the ground electrode 230 by the power supply device inside the casing 210 of the static elimination head 200C.

(3) In the first embodiment, the plurality of rectifying plates 240 of the rectifying plate unit 240U of the static elimination head 200B are arranged so as to form the honeycomb structure, but the present invention is not limited thereto. The plurality of rectifying plates 240 may be arranged so as to form a structure made of a plurality of other shapes.

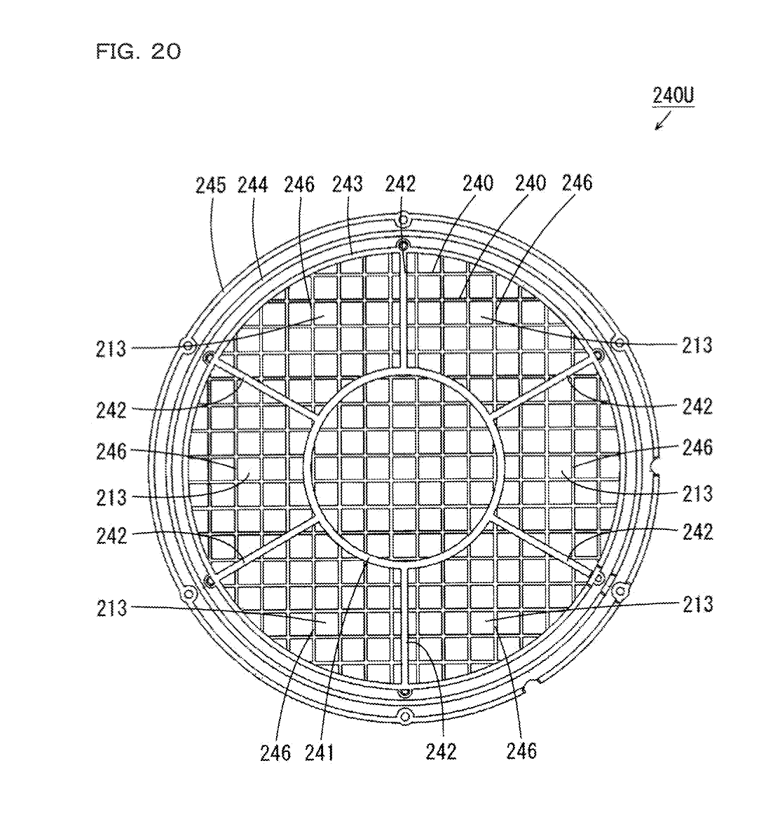

FIG. 20 is a plan view showing a first modified example of the rectifying plate unit 240U of the static elimination head 200B. As shown in FIG. 20, in the first modified example of the rectifying plate unit 240U, the plurality of rectifying plates 240 are arranged so as to form a structure made of a plurality of squares. Further, the plurality of barrier ribs 246 are arranged so as to form squares. The inside of each square formed by the plurality of barrier ribs 246 becomes the opening 213.

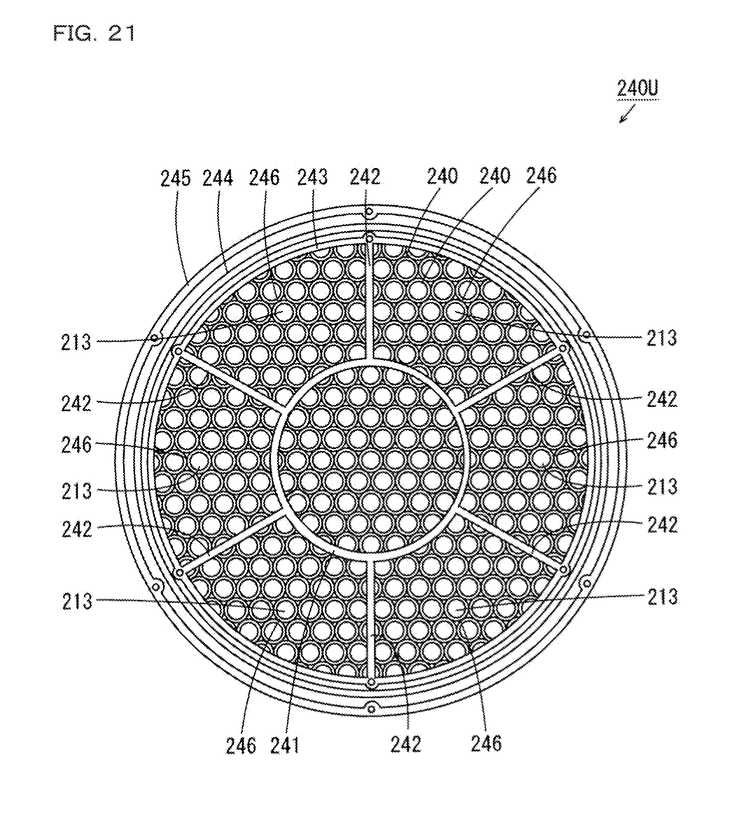

FIG. 21 is a plan view showing a second modified example of the rectifying plate unit 240U of the static elimination head 200B. As shown in FIG. 21, in the second modified example of the rectifying plate unit 240U, the plurality of rectifying plates 240 are arranged so as to form a structure made of a plurality of circles. Further, the plurality of barrier ribs 246 are arranged so as to form circles. The inside of each circle formed by the plurality of barrier ribs 246 becomes the opening 213.

Similarly, in the first embodiment, the plurality of rectifying plates 240 of the rectifying plate unit 240U of the static elimination head 200C may be arranged so as to form a structure made of a plurality of other shapes. In the second embodiment, the plurality of rectifying plates 140 of the rectifying plate unit 140U of the static eliminator 100 may be arranged so as to form a structure made of a plurality of other shapes.

(4) In the first embodiment, the static elimination needle 220 is arranged substantially at the center in the width direction of the casing 210 of the static elimination head 200A, but the present invention is not limited thereto. In the static elimination head 200A of Example 1, the static elimination needle 220 is arranged in a position different from the center in the width direction of the casing 210.

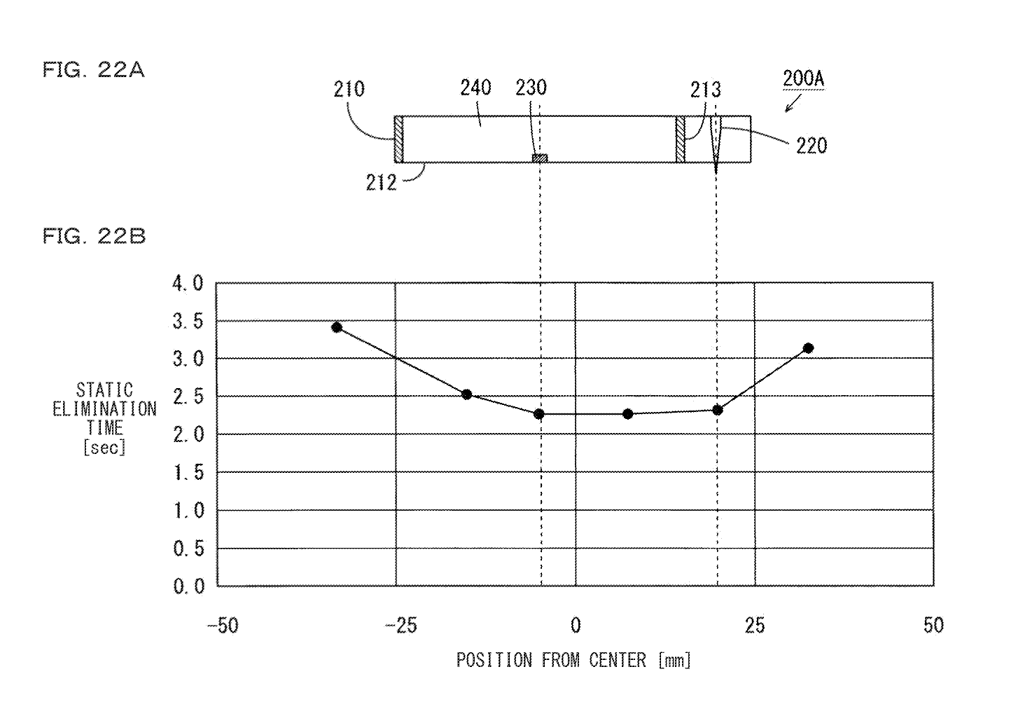

Here, static electricity on the static elimination object was eliminated by use of the static elimination head 200A of Example 1. FIGS. 22A and 22B are diagrams showing the static elimination head 200A of Example 1 and static elimination performance of the static eliminator 100 using the same.

FIG. 22A shows a schematic sectional view of a part of the static elimination head 200A of the example. The casing 210 of the static elimination head 200A of FIG. 22A has a width of 50 mm. The static elimination needle 220 is arranged in a position displaced from the center in the width direction of the casing 210 to one side thereof by 20 mm, and the ground electrode 230 is arranged in a position displaced to the other side thereof by 5 mm.

FIG. 22B shows static elimination performance of the static eliminator 100 using the static elimination head 200A of FIG. 22A. A vertical axis of FIG. 22B indicates static elimination time for the static elimination object and a horizontal axis thereof indicates a position from the center in the width direction of the casing 210. In FIG. 22B, the position displaced from the center in the width direction of the casing 210 to one side thereof is taken as a positive position, and the position displaced to the other side thereof is taken as a negative position.

When the static elimination needle 220 is arranged in a position different from the center in the width direction of the casing 210, a slight deviation occurs in a static elimination possible region. For this reason, as shown in FIG. 22B, the static elimination time for the static elimination object in the vicinity of the end in the width direction of the casing 210 slightly became longer than the static elimination time for the static elimination object in the vicinity of the center. When such an increase in static elimination time is permissible, the static elimination needle 220 may be arranged in a position different from the center in the width direction of the casing 210 of the static elimination head 200A.

Similarly, in the static elimination head 200C of the first embodiment, the static elimination needle 220 is arranged substantially at the center of the casing 210, but the present invention is not limited thereto. When an increase in static elimination time is permissible, the static elimination needle 220 may be arranged in a position different from the center of the casing 210 of the static elimination head 200C. In the static elimination head 200B of the first embodiment, the plurality of static elimination needles 220 are arranged at intervals of a substantially equal angle, but the present invention is not limited thereto. When an increase in static elimination time is permissible, the plurality of static elimination needles 220 may not be arranged at intervals of a substantially equal angle.

In the static eliminator 100 of the second embodiment, the static elimination needle 120 is arranged substantially at the center of the air flow outlet 112 of the casing 110, but the present invention is not limited thereto. When an increase in static elimination time is permissible, the static elimination needle 120 may be arranged in a position different from the center of the air flow inlet 111 of the casing 110.

(5) In the first embodiment, the ground electrode 230 of the static elimination head 200B includes the internal electrode 231 and the external electrode 233, but the present invention is not limited thereto. In the static elimination head 200B of Example 2, the ground electrode 230 includes the internal electrode 231 and the external electrode 233. The internal electrode 231 and the external electrode 233 are electrically connected through one connection electrode 232. In the static elimination head 200B of Example 3, the ground electrode 230 includes the internal electrode 231, but does not include the connection electrode 232 and the external electrode 233. In the static elimination head 200B of Example 4, the ground electrode 230 includes the external electrode 233, but does not include the internal electrode 231 and the connection electrode 232.

Static electricity on the static elimination object was eliminated by use of the static elimination heads 200B of Examples 2 to 4. Here, an AC voltage with a frequency of 33 Hz was applied to each static elimination needle 220. A positive voltage and a negative voltage to be applied to each static elimination needle 220 were set to 5.3 kV and −3.7 kV, respectively. Note that the positive voltage and the negative voltage are different due to a difference in ratio (duty ratio) between a period for applying the positive voltage and a period for applying the negative voltage. A distance between the needlepoint of each static elimination needle 220 and the static elimination object was set to 300 mm, and a wind velocity of the humidified air jetted from the air flow outlet 212 onto the static elimination object was set to 1 m/sec.

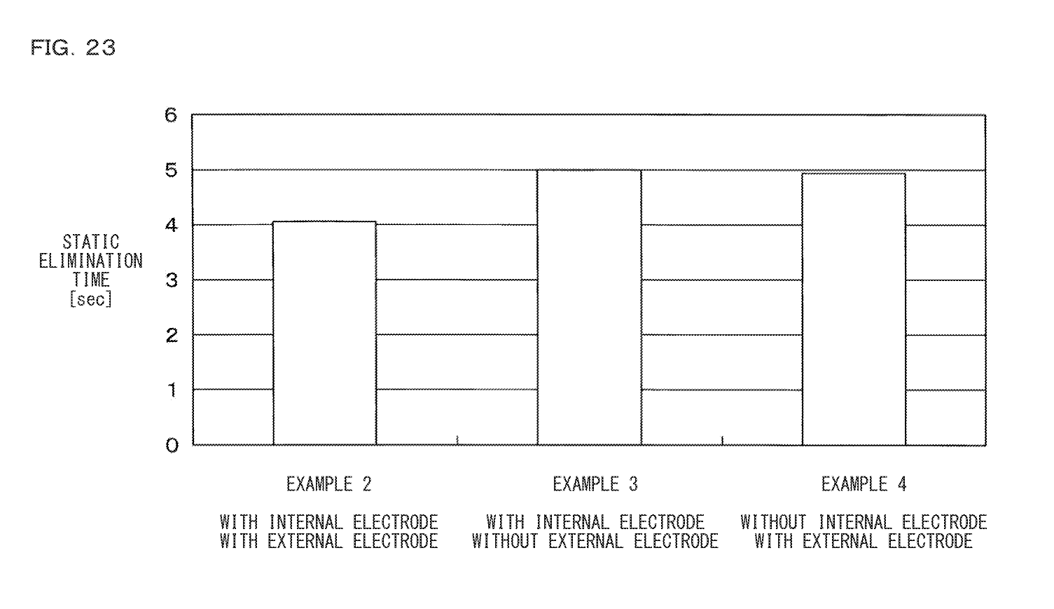

FIG. 23 is a diagram showing static elimination performance of the static eliminators 100 using the static elimination heads 200B of Examples 2 to 4. A vertical axis of FIG. 23 indicates static elimination time for the static elimination object. As shown in FIG. 23, the static elimination time in Examples 3 and 4 became longer than the static elimination time in Example 2. When such an increase in static elimination time is permissible, the ground electrode 230 of the static elimination head 200B may not include the internal electrode 231 or the external electrode 233. Further, even when the ground electrode 230 is not arranged in the static elimination head 200, in a case where a stable corona discharge can be generated, the ground electrode 230 may not be arranged in the static elimination head 200.

Further, there were produced a plurality of static elimination heads 200B each obtained by changing a distance between the internal electrode 231 and each static elimination needle 220. In the static elimination heads 200B in Examples 5, 6 and 7, distances between the internal electrode 231 and each static elimination needle 220 were respectively set to 10 mm, 20 mm, and 30 mm. By use of the static elimination heads 200B of Examples 5 to 7, static electricity on the static elimination object was eliminated. Conditions for the static elimination are similar to the conditions for the static elimination in Examples 2 to 4.

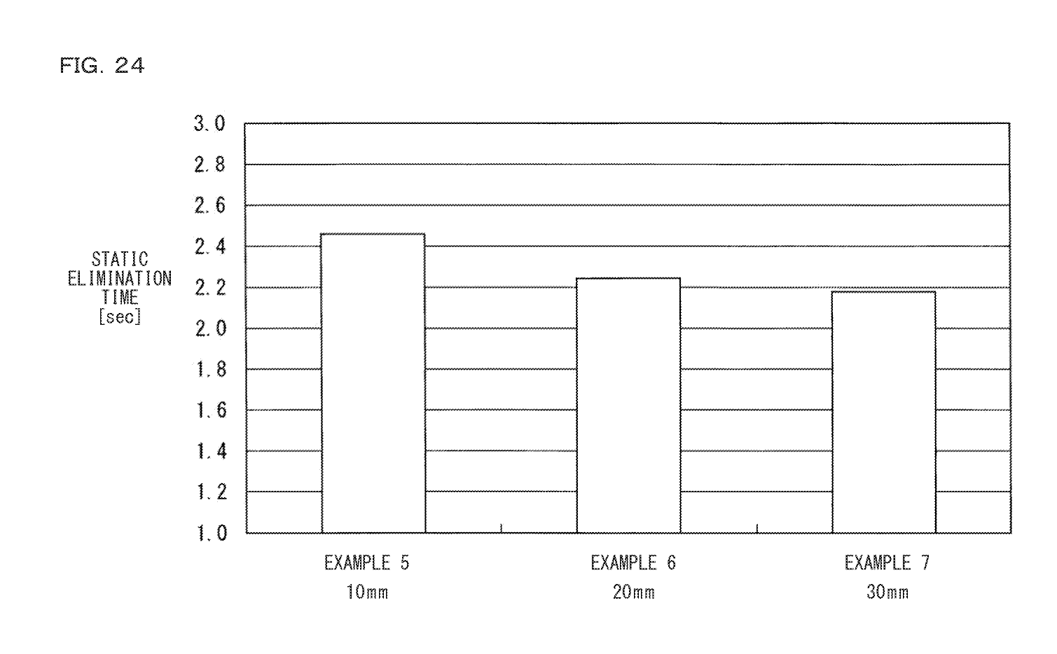

FIG. 24 is a diagram showing static elimination performance of the static eliminators 100 using the static elimination heads 200B of Examples 5 to 7. A vertical axis of FIG. 24 indicates static elimination time for the static elimination object. As shown in FIG. 24, the static elimination time in Example 6 became shorter than the static elimination time in Example 5. The static elimination time in Example 7 became shorter than the static elimination time in Example 6. It was confirmed from these results that the static elimination time for the static elimination object can be reduced by increasing the distance between the internal electrode 231 and each static elimination needle 220.

However, the static elimination time of the static eliminator 100 in the case of increasing the distance between the internal electrode 231 and each static elimination needle 220 by 30 mm became longer than the static elimination time in Example 7. This is considered to be caused by the decrease in the distance between the external electrode 233 and each static elimination needle 220. Therefore, it was confirmed that optimal static elimination performance can be obtained by arranging each static elimination needle 220 in an optimal position between the internal electrode 231 and the external electrode 233.

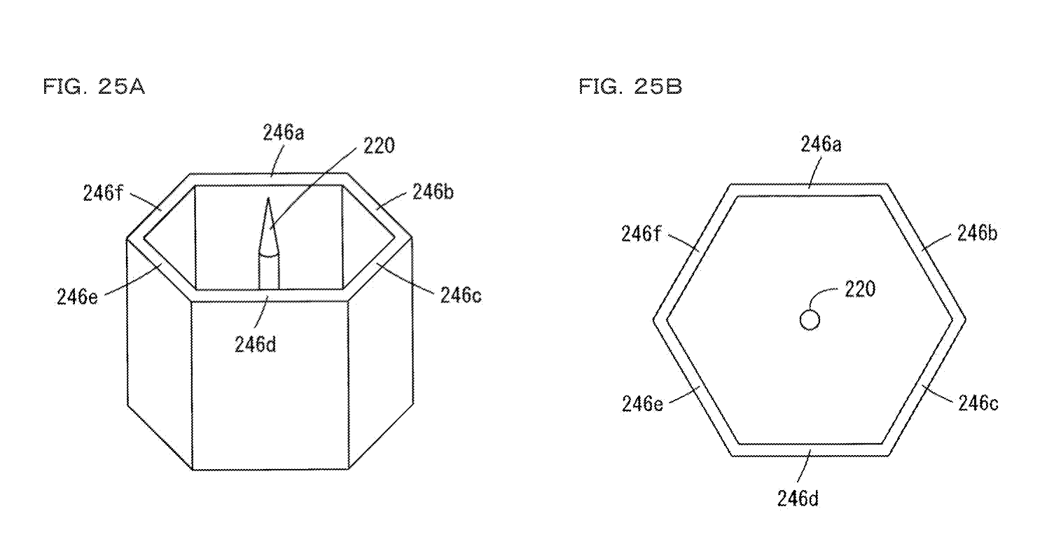

(6) In the first embodiment, the notch is formed in a part of the plurality of barrier ribs 246 surrounding each static elimination needle 220 of the static elimination head 200B, but the present invention is not limited thereto. FIGS. 25 to 28 are views respectively showing a plurality of barrier ribs 246 of the static elimination heads 200B of Examples 8 to 11. FIGS. 25A to 28A show perspective views of the plurality of barrier ribs 246, and FIGS. 25B to 28B show plan views of the plurality of barrier ribs 246.

In the static elimination heads 200B of Examples 8 to 11, six barrier ribs 246a to 246f are arranged so as to surround the static elimination needle 220 and form a hexagon. Further, the six barrier ribs 246a to 246f are arranged so as to be adjacent in this order. Accordingly, the barrier rib 246a and the barrier rib 246d are opposed to each other with the static elimination needle 220 therebetween. The barrier rib 246b and the barrier rib 246e are opposed to each other with the static elimination needle 220 therebetween. The barrier rib 246c and the barrier rib 246f are opposed to each other with the static elimination needle 220 therebetween.

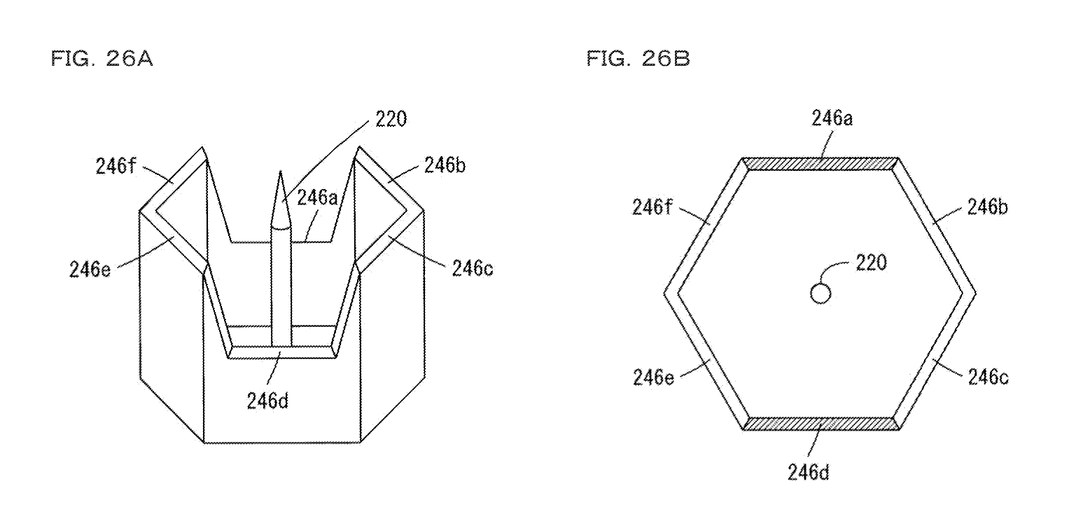

As shown in FIGS. 25A and 25B, in the static elimination head 200B of Example 8, a notch is not formed in any of the barrier ribs 246a to 246f. As shown in FIGS. 26A and 26B, in the static elimination head 200B of Example 9, notches in a substantially trapezoidal shape are formed in a pair of barrier ribs 246a, 246d opposed to each other with the static elimination needle 220 therebetween.

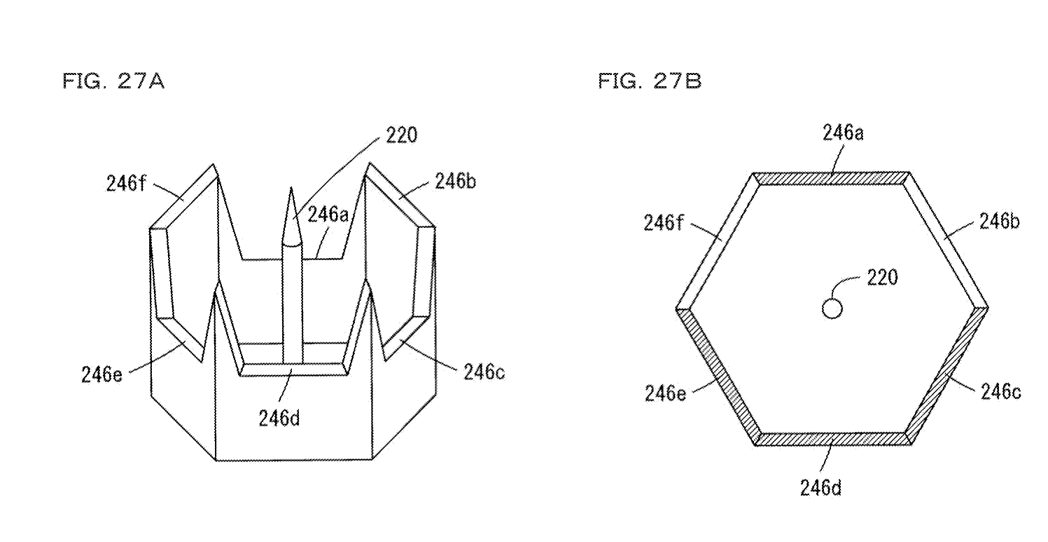

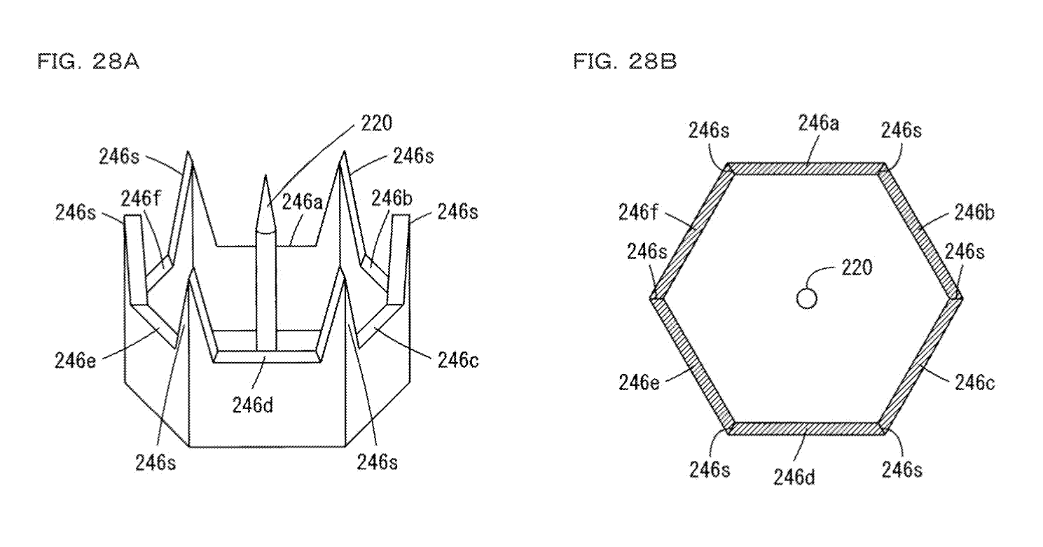

As shown in FIGS. 27A and 27B, in the static elimination head 200B of Example 10, notches in the substantially trapezoidal shape are formed in the pair of barrier ribs 246a, 246d opposed to each other with the static elimination needle 220 therebetween, and other two barrier ribs 246c, 246e. As shown in FIGS. 28A and 28B, in the static elimination head 200B of Example 11, notches in the substantially trapezoidal shape are formed in all the barrier ribs 246a to 246f. Note that in FIGS. 25B to 28B, hatched patterns are added to portions of the barrier ribs 246a to 246f where the notches are formed.

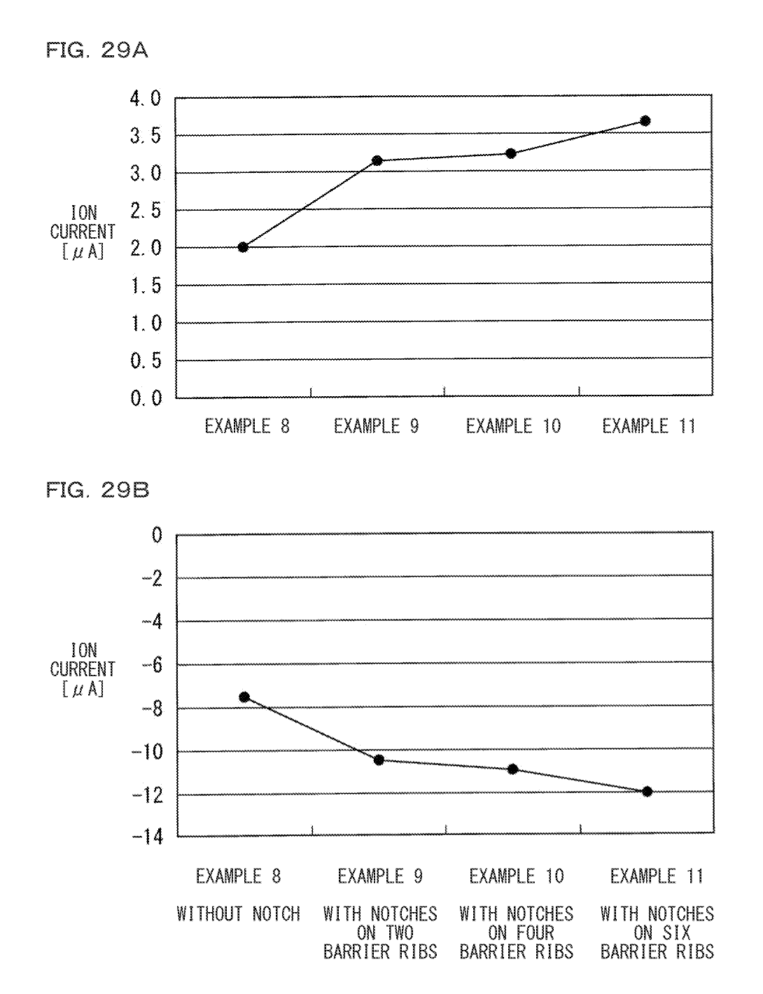

Static electricity on the static elimination object was eliminated by use of the static elimination heads 200B of Examples 8 to 11. Conditions for the static elimination are similar to the conditions for the static elimination in Examples 2 to 4. FIGS. 29A and 29B are diagrams showing static elimination performance of the static eliminators 100 using the static elimination heads 200B of Examples 8 to 11. A vertical axis of FIG. 29A indicates an ion current by corona discharge which is generated when a positive voltage is applied to the static elimination needle 220. A vertical axis of FIG. 29B indicates an ion current by corona discharge which is generated when a negative voltage is applied to the static elimination needle 220.

As shown in FIGS. 29A and 29B, the ion current in Example 9 became larger than the ion current in Example 8. The ion current in Example 10 became larger than the ion current in Example 9. The ion current in Example 11 became larger than the ion current in Example 10. It was confirmed from these results that the ion current can be increased by forming notches in the plurality of barrier ribs 246a to 246f.

This is considered to be because reduction in obstacles between the needlepoint of the static elimination needle 220 and the ground electrode 230 can lead to efficient generation of corona discharge between the static elimination needle 220 and the ground electrode 230. Accordingly, when corona discharge can be generated with sufficiently high efficiency, a notch may not be formed in a part of the plurality of barrier ribs 246a to 246f.

In the present example, since the notches in the substantially trapezoidal shape are formed in the plurality of barrier ribs 246a to 246f, a plurality of protrusions 246s are formed in boundary portions (corners of the hexagons) of the plurality of barrier ribs 246a to 246f. Similarly to the plurality of projections 218 of FIG. 5, the plurality of protrusions 246s have the function of protecting the static elimination needle 220. Even when the static elimination needle 220 collides with the static elimination object or another object, the plurality of protrusions 246s prevent the needlepoint of the static elimination needle 220 from being bent.

When the function of protecting the static elimination needle 220 is unnecessary, a part of the plurality of barrier ribs 246a to 246f may be removed so as not to form the protrusion 246s. Alternatively, a part of the plurality of barrier ribs 246a to 246f may be removed such that the plurality of barrier ribs 246a to 246f are flush with the plurality of rectifying plates 240 surrounding the barrier ribs 246a to 246f.

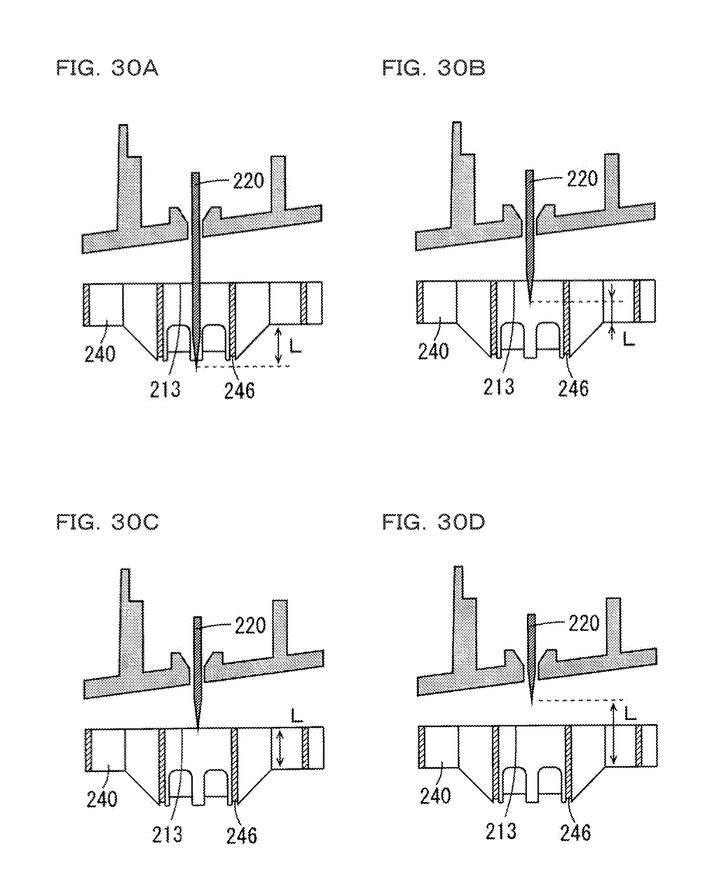

(7) In the first embodiment, the static elimination needle 220 is arranged such that its needlepoint projects from the end (hereinafter referred to as one end) of the rectifying plate 240 in the flow-out direction of the humidified air, but the present invention is not limited thereto. Similarly, in the second embodiment, the static elimination needle 120 is arranged such that its needlepoint projects from the one end of the rectifying plate 140, but the present invention is not limited thereto. FIGS. 30A to 30D are views showing static elimination heads of Examples 12 to 15. The static elimination heads of FIGS. 30A to 30D each have a similar shape to that of the static elimination head 200B of FIG. 9. FIGS. 30A to 30D respectively show parts of cross sections of the static elimination heads of Examples 12 to 15.

As shown in FIG. 30A, in the static elimination head of Example 12, the needlepoint of the static elimination needle 220 projects from the one end of the rectifying plate 240. The distance L from the one end of the rectifying plate 240 to the needlepoint of the static elimination needle 120 is 10 mm. As shown in FIG. 30B, in the static elimination head of Example 13, the needlepoint of the static elimination needle 220 is located at the center of the rectifying plate 240 in the flow-out direction of the humidified air. The distance L from the one end of the rectifying plate 240 to the needlepoint of the static elimination needle 120 is −5 mm.

As shown in FIG. 30C, in the static elimination head of Example 14, the needlepoint of the static elimination needle 220 is located on a plane being flush with the other end of the rectifying plate 240. The distance L from the one end of the rectifying plate 240 to the needlepoint of the static elimination needle 120 is −10 mm. As shown in FIG. 30D, in the static elimination head of Example 15, the needlepoint of the static elimination needle 220 is located above the rectifying plate 240. The distance L from the one end of the rectifying plate 240 to the needlepoint of the static elimination needle 220 is −16 mm.

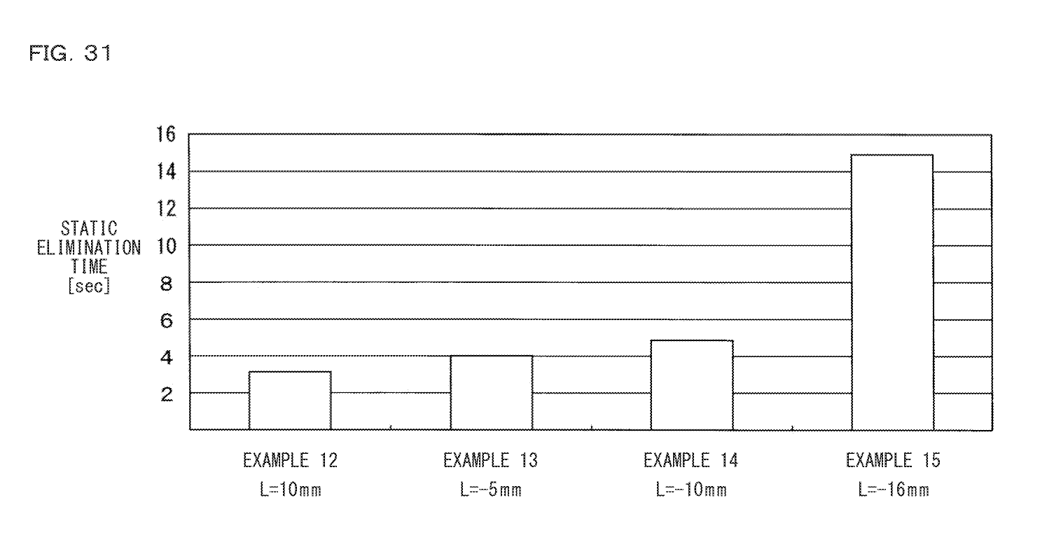

Static electricity on the static elimination object was eliminated by use of the static elimination heads of Examples 12 to 15. Conditions for the static elimination are similar to the conditions for the static elimination in Examples 2 to 4. FIG. 31 is a diagram showing static elimination performance of static eliminators using the static elimination heads of Examples 12 to 15. A vertical axis of FIG. 31 indicates static elimination time for the static elimination object.

As shown in FIG. 31, the static elimination time in Example 13 slightly became longer than the static elimination time in Example 12. The static elimination time in Example 14 slightly became longer than the static elimination time in Example 13. The static elimination time in Example 15 became longer than the static elimination time in Example 14. It was confirmed from these results that the static elimination time for the static elimination object can be reduced by arranging the needlepoint of the static elimination needle 220 in a position on the more downstream side of the humidified air. This is considered to be caused by the rectifying plate 240 being attached to (charged with) the generated ions.

On the other hand, when such an increase in static elimination time is permissible, the static elimination needle 220 may not be arranged such that its needlepoint projects from the end of the rectifying plate 240 in the first embodiment. Similarly, in the second embodiment, the static elimination needle 120 may not be arranged such that its needlepoint projects from the end of the rectifying plate 140.

(8) In the first embodiment, the ground electrode 230 is arranged so as to surround at least a part of the needlepoint of the static elimination needle 220, but the present invention is not limited thereto. Similarly, in the second embodiment, the ground electrode 130 is arranged so as to surround at least a part of the needlepoint of the static elimination needle 120, but the present invention is not limited thereto.

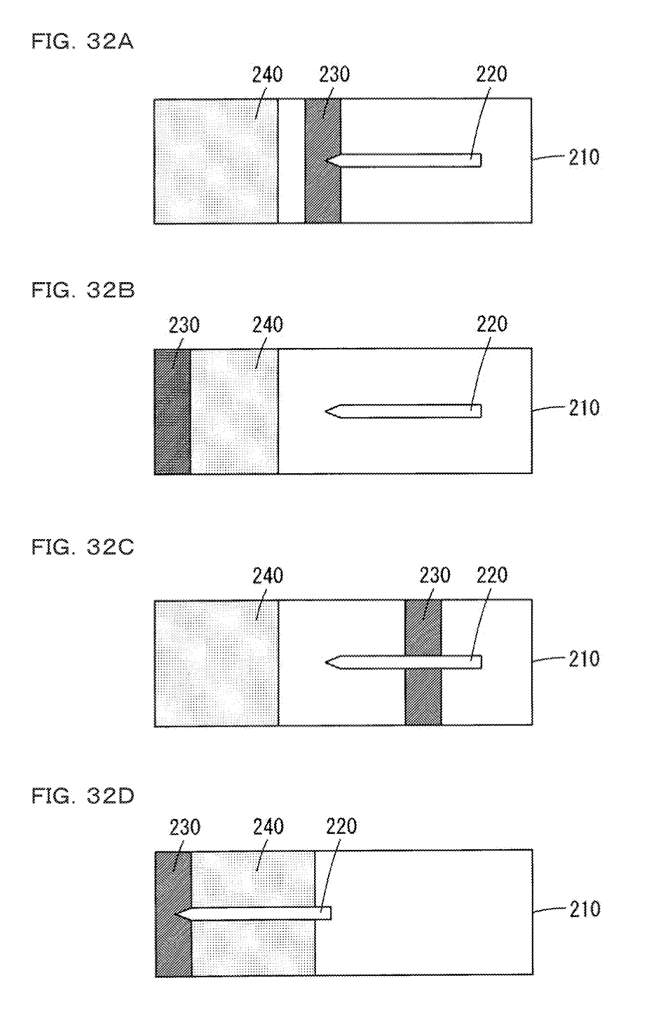

FIGS. 32A to 32D are views showing static elimination heads of Examples 16 to 19. The static elimination heads of FIGS. 32A to 32D each have a similar shape to that of the static elimination head 200C of FIG. 13. FIGS. 32A to 32D respectively show positional relations among the static elimination needle 220, the ground electrode 230, and the rectifying plate 240 in the static elimination heads of Examples 16 to 19. Note that, in each of FIGS. 32A to 32D, a hatched pattern is added to the ground electrode 230 and a dotted pattern is added to the rectifying plate 240 in order to facilitate understanding.

As shown in FIG. 32A, in the static elimination head of Example 16, the ground electrode 230 is arranged at the needlepoint of the static elimination needle 220, and the rectifying plate 240 is arranged on the more downstream side of the humidified air than the needlepoint of the static elimination needle 220. As shown in FIG. 32B, in the static elimination head of Example 17, the ground electrode 230 and the rectifying plate 240 are arranged on the more downstream side of the humidified air than the needlepoint of the static elimination needle 220.

As shown in FIG. 32C, in the static elimination head of Example 18, the ground electrode 230 is arranged on the more upstream side of the humidified air than the needlepoint of the static elimination needle 220, and the rectifying plate 240 is arranged on the more downstream side of the humidified air than the needlepoint of the static elimination needle 220. As shown in FIG. 32D, in the static elimination head of Example 19, the ground electrode 230 is arranged at the needlepoint of the static elimination needle 220, and the rectifying plate 240 is arranged on the more upstream side of the humidified air than the needlepoint of the static elimination needle 220.

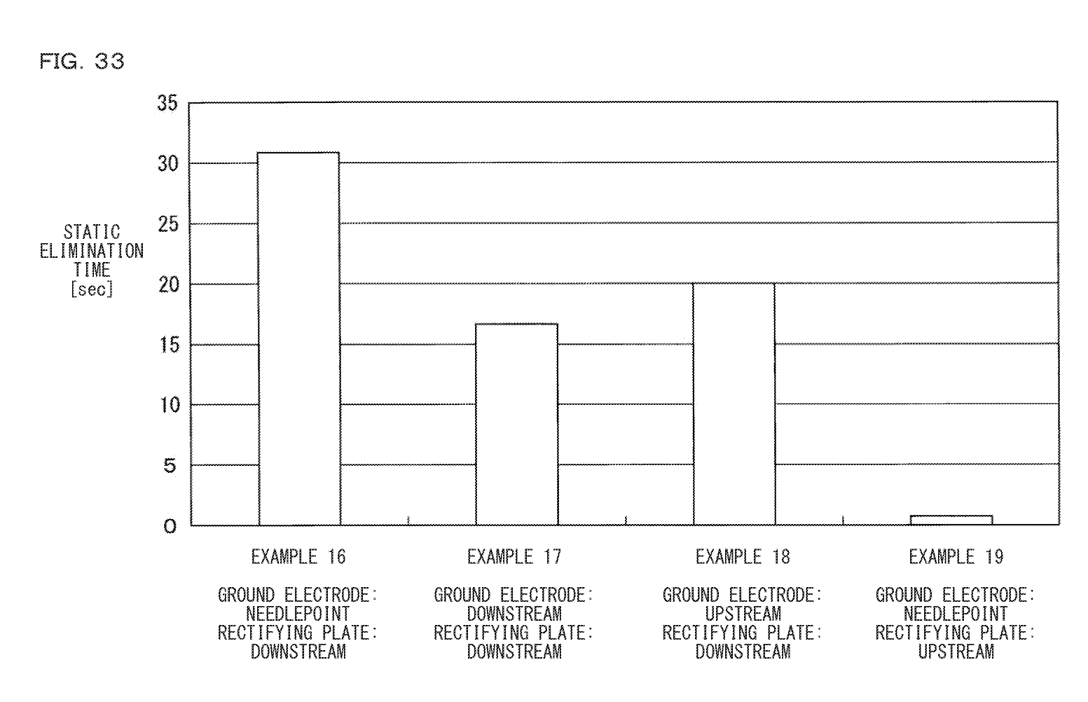

Static electricity on the static elimination object was eliminated by use of the static elimination heads of Examples 16 to 19. Conditions for the static elimination are similar to the conditions for the static elimination in Examples 2 to 4. FIG. 33 is a diagram showing static elimination performance of static eliminators using the static elimination heads of Examples 16 to 19. A vertical axis of FIG. 33 indicates static elimination time for the static elimination object.

As shown in FIG. 33, the static elimination time in Examples 16 to 18 became longer than the static elimination time in Example 19. It was confirmed from these results that the static elimination time for the static elimination object can be reduced by arranging the ground electrode 230 at the needlepoint of the static elimination needle 220 and arranging the rectifying plate 240 on the more upstream side of the humidified air than the needlepoint of the static elimination needle 220.

This is considered to be because the efficiency in corona discharge is improved by arranging the ground electrode 230 so as to be vertical to the static elimination needle 220 and intersect with the plane located at the tip of the static elimination needle 220. Further, this is considered to be because charging of the rectifying plate 240 with the generated ions is reduced by arranging the static elimination needle 220 so as to project more than the tip of the rectifying plate 240 in the flow-out direction of the humidified air.

On the other hand, when such an increase in static elimination time is permissive, in the first embodiment, the ground electrode 230 may be arranged in a position different from the needlepoint of the static elimination needle 220. Further, the rectifying plate 240 may be arranged on the more downstream side of the humidified air than the needlepoint of the static elimination needle 220. Similarly, in the second embodiment, the ground electrode 130 may be arranged in a position different from the needlepoint of the static elimination needle 120. Further, the rectifying plate 140 may be arranged on the more downstream side of the humidified air than the needlepoint of the static elimination needle 120.

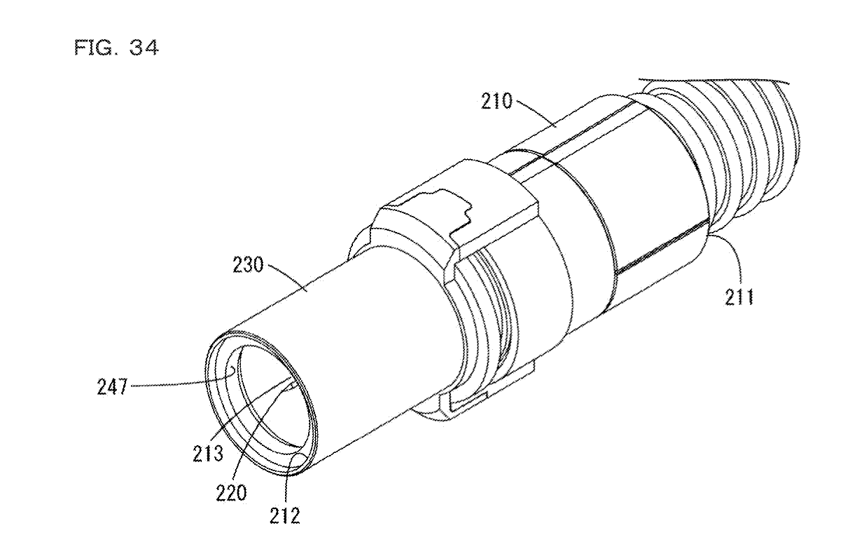

(9) In the first embodiment, the rectifying plate 240 is provided in the static elimination head 200, but the present invention is not limited thereto. Similarly, in the second embodiment, the rectifying plate 140 is provided in the static eliminator 100, but the present invention is not limited thereto. FIG. 34 is an external perspective view showing a static elimination head in the case where the rectifying plate 240 is not provided. In the static elimination head of FIG. 34, the rectifying plate 240 and the barrier rib 248 are not provided in the rectifying plate unit 240U. Accordingly, the inside of the casing 247 of the rectifying plate unit 240U becomes the opening 213.

As Examples 20 and 21, humidified air was jetted respectively from the static elimination heads of FIGS. 13 and 34 to an environment at a peripheral temperature of 25° C. with a wind amount of 0.3 m³/min. In these cases, relative humidities of air in positions separated from the respective static elimination heads were measured.

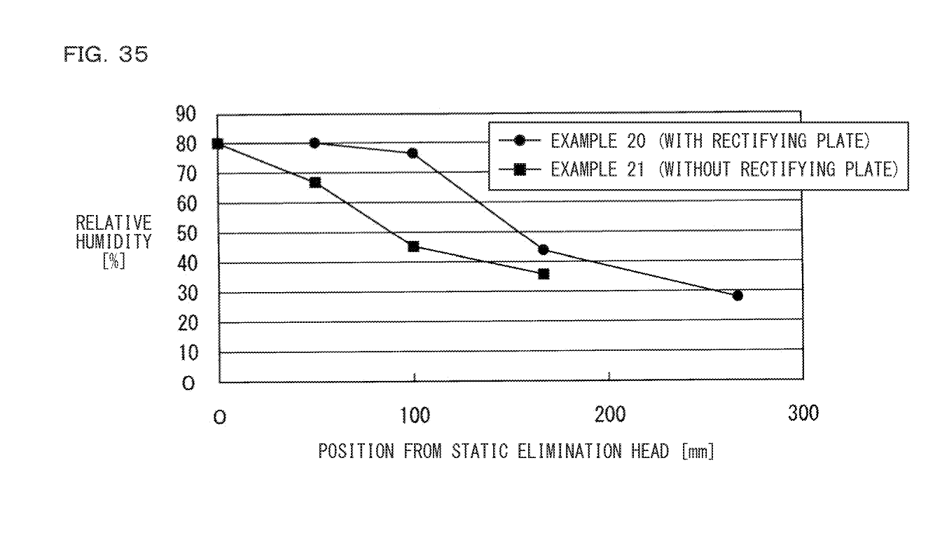

FIG. 35 is a graph showing the relation between the position from the static elimination head and the relative humidity of the air. A horizontal axis of FIG. 35 indicates a position from the air flow outlet 212 of each static elimination head, and a vertical axis indicates a relative humidity of the air. A result concerning the static elimination head of FIG. 13 having the rectifying plate 240 is indicated by black circles, and a result concerning the static elimination head of FIG. 34 without the rectifying plate 240 is indicated by black squares.

As shown in FIG. 35, the relative humidity of the air in an arbitrary position from the static elimination head of FIG. 13 became higher than the relative humidity of the air in the same position from the static elimination head of FIG. 34. It was thereby confirmed that the static elimination head 200 provided with the rectifying plate 240 can jet the humidified air to a farther distance than the static elimination head 200 without the rectifying plate 240.

Meanwhile, when it is not necessary to jet the humidified air to a far distance from the static elimination head 200, the rectifying plate 240 may not be provided in the static elimination head 200. Similarly, when it is not necessary to jet the humidified air to a far distance from the air flow outlet 112 of the static eliminator 100, the rectifying plate 140 may not be provided in the static eliminator 100.

(10) In the above embodiments, the static elimination needles 120, 220 are used as the static elimination electrodes, but the present invention is not limited thereto. In place of the static elimination needles 120, 220, another electrode such as a wire may be used as the static elimination electrode.

### [4] Correspondence Relation between Each Constitutional Element of Claims and Each Part of Embodiments

Hereinafter, the example of the correspondence between each constitutional element of the claims and each part of the embodiments will be described, but the present invention is not limited to the following examples.

In the above embodiments, the static eliminator 100 is an example of the static eliminator, the power supply device 352 is an example of the power supply device, and the heater 320 is an example of the temperature adjusting part. The controller 351 is an example of each of the first and second controllers, the temperature measuring part 314 is an example of the temperature measuring part, and the temperature measuring part 214 or the display part 313 is an example of the external temperature acquiring part.

In the first embodiment, the humidified air generating part 300 is an example of the humidified air generating part, the air flow outlet 212 is an example of the flow outlet, the static elimination head 200 is an example of the holding body, the static elimination needle 220 is an example of the static elimination needle, and the ground electrode 230 is an example of the electrode. The respective power supply devices 215, 352 are examples of the first and second power supply devices, the display part 313 is an example of the input part, the air flow inlet 211 is an example of the flow inlet, the casing 210 is an example of the casing, the hose 101 is an example of the supply tube, and the rectifying plate 240 is an example of the rectifying plate.

In the first example of the static elimination head 200, the static elimination head 200A is an example of the first static elimination head, and the ground electrode 230 is an example of each of the first and second counter electrodes or an example of the first electrode. The air flow outlet 212 is an example of each of the first and second flow outlets, and the casing 210 is an example of the first casing, and the static elimination needle 220 is an example of the first static elimination needle.

In the second example of the static elimination head 200, the static elimination head 200B is an example of the first static elimination head, the casing 210 is an example of the first casing, the static elimination needle 220 is an example of the first static elimination needle, and the ground electrode 230 is an example of the first electrode. In the third example of the static elimination head 200, the static elimination head 200C is an example of the second static elimination head, the casing 210 is an example of the second casing, the static elimination needle 220 is an example of the second static elimination needle, and the ground electrode 230 is an example of the second electrode.

In the second embodiment, the humidifying filter 330 is an example of humidified air generating part, the air flow outlet 112 is an example of the flow outlet, and the casings 110, 141 are examples of the holding body or the casing. The static elimination needle 120 is an example of the static elimination needle, the ground electrode 130 is an example of the electrode, the display part 113 is an example of the input part, the air flow inlet 111 is an example of the flow inlet, and the rectifying plate 140 is an example of the rectifying plate.

As each constitutional element of the claims, other variety of elements having configurations or functions recited in the claims can also be used.

The present invention can be efficiently used to prevent the static elimination object from being charged.

What is claimed is:

1. A static eliminator for eliminating static electricity on an object, the static eliminator comprising:
a humidified air generating part that humidifies air to generate humidified air;
a holding body that has a flow outlet for allowing the humidified air, generated by the humidified air generating part, to flow out;
one or a plurality of static elimination electrodes held in the holding body;
an electrode that is held in the holding body; and
a power supply device that applies a voltage between the one or the plurality of static elimination electrodes and the electrode to generate corona discharge,
wherein the one or the plurality of static elimination electrodes are arranged in the holding body such that ions generated by the corona discharge are sent out by the humidified air that is allowed to flow out of the flow outlet.

2. The static eliminator according to claim 1, further comprising
a temperature adjusting part that adjusts a temperature of air,
wherein the humidified air generating part humidifies air whose temperature has been adjusted by the temperature adjusting part.

3. The static eliminator according to claim 2, further comprising
a first controller that controls the temperature adjusting part such that an absolute humidity of the humidified air flowing out of the flow outlet is equal to or lower than a saturated steam amount of air around the object.

4. The static eliminator according to claim 3, further comprising:
a temperature measuring part that measures a temperature of the humidified air generated by the humidified air generating part; and
an external temperature acquiring part that acquires a temperature of external air,
wherein the first controller controls the temperature adjusting part such that the humidified air temperature measured by the temperature measuring part is equal to or lower than the external air temperature acquired by the external temperature acquiring part.

5. The static eliminator according to claim 2, further comprising:
a temperature measuring part that measures a temperature of the humidified air generated by the humidified air generating part;
an external temperature acquiring part that acquires a temperature of external air;
an input part for inputting a target relative humidity; and
a second controller that estimates an absolute humidity of the humidified air based on the humidified air temperature measured by the temperature measuring part, and controls the temperature adjusting part such that a relative humidity at the external air temperature acquired by the external temperature acquiring part becomes the target relative humidity, the relative humidity being calculated based on the absolute humidity.

6. The static eliminator according to claim 1, wherein
the electrode includes first and second counter electrodes that are arranged so as to be opposed to each other,
the one or the plurality of static elimination electrodes are arranged between the first counter electrode and the second counter electrode, and
the flow outlet includes a first flow outlet that allows the humidified air to flow out between the first counter electrode and the one or the plurality of static elimination electrodes, and a second flow outlet that allows the humidified air to flow out between the second counter electrode and the one or the plurality of static elimination electrodes.

7. The static eliminator according to claim 1, wherein the one or the plurality of static elimination electrodes are provided so as to be located in the humidified air that is allowed to flow out of the flow outlet.

8. The static eliminator according to claim 1, wherein
the electrode is formed so as to annularly surround a periphery of each of the static elimination electrodes, and
the flow outlet allows the humidified air to flow out to an annular region between each of the static elimination electrodes and the electrode.

9. The static eliminator according to claim 1, wherein
the holding body includes a casing that has an internal space, a flow inlet, and the flow outlet, and houses at least a part of the one or the plurality of static elimination electrodes, and
the static eliminator further comprises a supply tube that leads the humidified air generated by the humidified air generating part to the flow inlet of the casing.

10. The static eliminator according to claim 9, wherein
the casing includes first and second casings,
the one or the plurality of static elimination electrodes include a first number of first static elimination electrodes that are held in the first casing, and a second number of second static elimination electrodes that are held in the second casing,
the first number is larger than the second number,
the electrode includes a first electrode that is held in the first casing and a second electrode that is held in the second casing,
the power supply device includes a first power supply device that applies a voltage between the first static elimination electrode and the first electrode, and a second power supply device that applies a voltage between the second static elimination electrode and the second electrode,
the first casing, the first static elimination electrode, the first electrode, and the first power supply device constitute a first static elimination head,
the second casing, the second static elimination electrode, and the second electrode constitute a second static elimination head, and
the first and second static elimination heads are selectively connectable to and removable from the humidified air generating part.

11. The static eliminator according to claim 1, wherein the holding body includes a casing that has the flow outlet and houses at least a part of the one or the plurality of static elimination electrodes and the humidified air generating part.

12. The static eliminator according to claim 1, wherein the electrode is arranged so as to be vertical to each of the static elimination electrodes and intersect with a plane located at a tip of each of the static elimination electrodes.

13. The static eliminator according to claim 1, further comprising
a rectifying plate that is held in the holding body,
wherein the rectifying plate is provided so as to rectify the humidified air, which is allowed to flow out of the flow outlet, in a fixed direction.

14. The static eliminator according to claim 13, wherein the one or the plurality of static elimination electrodes are arranged so as to project more than the tip of the rectifying plate in a flow-out direction of the humidified air.

15. A static elimination head, which is connectable to a humidified air generating part for humidifying air to generate humidified air through a supply tube, and eliminates static electricity on an object, the static elimination head comprising:
a holding body that is connectable to the humidified air generating part through the supply tube, and has a flow outlet for allowing the humidified air generated by the humidified air generating part to flow out;
one or a plurality of static elimination electrodes that are capable of applying a voltage for generating corona discharge, and are held in the holding body; and
an electrode that is capable of applying a voltage for generating corona discharge, and is held in the holding body,
wherein the one or the plurality of static elimination electrodes are arranged in the holding body such that ions generated by the corona discharge are sent out by the humidified air that is allowed to flow out of the flow outlet.
